(19) United States
(12) Patent Application Publication
(10) Pub. No.: US 2017/0132633 A1
(43) Pub. Date: May 11, 2017

(54) SYSTEMS AND METHODS PROVIDING PAYMENT TRANSACTIONS

(71) Applicant: PSI SYSTEMS, INC., Palo Alto, CA (US)

(72) Inventor: Harry T. WHITEHOUSE, Portola Valley, CA (US)

(21) Appl. No.: 15/321,963

(22) PCT Filed: Jun. 9, 2015
(86) PCT No.: PCT/US15/34984

§ 371 Date: Dec. 23, 2016

Related U.S. Application Data
(60) Provisional application No. 62/018,446, filed on Jun. 27, 2014.

(51) Int. Cl. G06Q 20/40; G06Q 20/38; G06Q 20/32; H04L 29/06

(52) U.S. Cl. CPC G06Q 20/4014; H04L 63/123; H04L 63/08; G06Q 20/3829; G06Q 20/385; G06Q 20/3274; G06Q 2220/00

(57) ABSTRACT

Systems and methods to implement a payment platform for users using financial accounts support making payments using a (client) computing device. One aspect of the disclosure relates to systems and methods to effectuate performance of payments and/or secured payment transactions. Payments may refer to the transfer of value between users. Payment transactions may refer to transactions that form at least a part of a payment.

### FIELD

The disclosure relates to systems and methods for implementing a payment platform.

### BACKGROUND

A variety of payment systems and methods exist, including but not limited to payments using credit cards, debit cards, checks, and/or other types of payments. A variety of electronic payment systems exist, including but not limited to automated clearing house (ACH) payments, electronic (virtual) checks, digital currencies, PayPal™, and/or other electronic payment systems. Each system may be characterized by varying and specific levels of ease of use, points of access, costs, fees, risks, security, and/or other characteristics. Some payment systems require accounts with financial institutions, e.g., banks. Some people may, for various reasons, have no access or limited access to certain types of financial institutions. The need for (some) financial services may be underserved and/or unserved.

Users can obtain financial accounts from financial institutions, also referred to as financial account providers. Common examples of financial accounts include checking accounts with a bank or credit union. Accessing accounts online may be known. Accessing services, applications, and web pages via the internet is known. Presenting and/or providing information via the internet, in particular through client computing platforms, is known.

### SUMMARY

One aspect of the disclosure relates to systems and methods to effectuate performance of payments and/or secured payment transactions. Payments may refer to the transfer of value between users. Payment transactions may refer to transactions that form at least a part of a payment. For example, a payment may include one or more payment transactions. For example, a payment from a first user to a second user may include a payment transaction between the first user and an intermediary agent or bank, and another payment transaction between the intermediary agent or bank and the second user. In some implementations, performance may include obtaining one or more attributes of a payment and/or secured payment transaction from a first user (e.g., a payer or payer user), such as an amount, presenting the one or more attributes to a second user (e.g., a payee or payee user), and receiving, from the second user, information related to effectuation of a payment and/or secured payment transaction that corresponds to the one or more attributes.

In some implementations, performance of payments and/or secured payment transactions may include obtaining one or more attributes of a payment and/or secured payment transaction from at least one user, authenticating the payment and/or secured payment transaction, and initiating a payment and/or secured payment transaction that corresponds to the obtained attributes.

In some implementations, performance of payments and/or secured payment transactions may include presenting one or more attributes of a payment and/or secured payment transaction to a payer user, obtaining an amount to be deposited to an account of a payee user, obtaining authorization form the payer user; and initiating the payment and/or secured payment transaction in which the obtained amount will be debited from the first account and deposited to the second account.

In some implementations, performance of payments and/or secured payment transactions may include obtaining, from a payer user, a token generation request for generation of a payment token that is redeemable for a first amount, generating the payment token, transmitting the payment token to the payer user, obtaining, from a payee user, a token redemption request for redemption of a payment token representing a second amount, verifying authenticity of the obtained token from the payee user, and redeeming the obtained token by depositing the second amount in an account of the payee user.

In some implementations, performance of payments and/or secured payment transactions may include issuing a token generation request for generation of a payment token that is redeemable for a first amount and authorizes the first amount to be debited from an account of a payer user, receiving the payment token, and transferring the payment token to a payee user.

In some implementations, performance of payments and/or secured payment transactions may include obtaining a payment token that represents a value redeemable for an amount, issuing a token redemption request that includes the obtained payment token, and receiving a confirmation of the authentication and redemption of the payment token, wherein the confirmation confirms a transfer of the amount from a first account to a second account.

These and other objects, features, and characteristics of the computing devices, servers, systems and/or methods disclosed herein, as well as the methods of operation and functions of the related elements of structure and the combination of parts and economies of manufacture, will become more apparent upon consideration of the following description and the appended claims with reference to the accompanying figures, all of which form a part of this specification, wherein like reference numerals designate corresponding parts in the various figures. It is to be expressly understood, however, that the figures are for the purpose of illustration and description only and are not intended as a definition of any limits. As used in the specification and in the claims, the singular form of “a”, “an”, and “the” include plural referents unless the context clearly dictates otherwise. As used in the specification and in the claims, in a list of items that includes the separator “and/or”, combinations of those items, insofar as practically possible, are envisioned as implementations.

### BRIEF DESCRIPTION OF THE DRAWINGS

FIG. 1 schematically illustrates a system configured to implement a payment platform in accordance with one or more implementations.

FIGS. 2A, 2B, and 2C illustrate exemplary graphical user interfaces as may be used in a payment system in accordance with one or more implementations.

FIGS. 3, 4, and 5 illustrate methods for implementing and/or using a payment platform in accordance with one or more implementations.

FIG. 6 and FIG. 10 illustrate flow diagrams of a postage indicium and/or payment token issuing system in accordance with one or more implementations.

FIGS. 7A, 7B, 7C, 7D, 7E, 7E, 7F, and 7G illustrate exemplary graphical user interfaces as may be used in a payment system in accordance with one or more implementations.

FIG. 8 illustrates a table that includes an exemplary construct/format of a postage indicium or payment token in accordance with one or more implementations.

FIG. 9 illustrates an exemplary client-generated message structure to request a payment token.

### DETAILED DESCRIPTION

This disclosure describes various example implementations of a new class of digitally signed, uniquely serialized currency packets. The currency packets (also referred to as “payment tokens” or simply “tokens”) may be used once and only once for the transfer of funds from one party to another. The payment tokens may be used to purchase any type of goods and/or services. In some implementations, the payment tokens may be based at least in part on existing postage evidencing protocols, particularly various security protocols required thereby to ensure the integrity of the tokens utilized as currency. Systems and methods are described to manage payments, withdrawals, deposits, transfers, auditing, reporting, and/or other functionality. The disclosure describes an alternative to credit cards, debit cards, ACH, and/or other payment methods, and may offer lower transfer fees (i.e., merchant fees), improved security, and other advantages as will become evident herein.

This disclosure describes an advancement of the utility of a secure payment account by allowing such an account (and/or an account that supports similar features and is supported on a similar system architecture as a postage account) to be used to securely purchase goods and/or services, in lieu of using this type of account to purchase and print postage to mail or ship articles. In some implementations, a secure payment account may utilize an (existing) postage account. Alternatively, and/or simultaneously, in some implementations, a secure payment account may utilize a separate and/or different account which may be linked to, similar to, and/or based on an account supporting similar features as a postage account and/or being supported on a similar system architecture as a postage account.

An existing PC postage network, or another network similarly configured as is described herein, may be used to facilitate the generation and performance of and payments in a streamlined, secure, and/or highly auditable way. In some implementations described in this disclosure, a payer may have an existing “postage” account, such as through an existing postal authority (e.g., USPS), which may be utilized as the secured payment account from which the payment tokens may be generated. However, in some other implementations, the secured payment account may be an account that is not or cannot be used for purchasing and printing postage, but rather specifically as a secured payment account for other general payments. In some implementations, the secured payment account may be similar to a credit and/or debit card account in some regards, but the mechanism of funds transfer need not involve card swipes or card numbers typed into a payment screen. Rather, digitally signed tokens and/or payment indicia (referred to herein as a payment token) may be produced on a mobile device screen, in hard copy form (e.g., printout from a computerized device), and/or in other ways and/or formats, and which may be subsequently scanned by, received by (or otherwise transferred to) the funds recipient. The digitally signed tokens may provide a mechanism of authentication and verification of the transaction and serve as the actual currency itself to be transferred between parties without reference to or dependence upon other financial instruments or accounts. A system architecture including a centralized backbone may provide enhanced security mechanisms for the payment tokens, the secured payment accounts, and the ensuing transactions, such as to confirm its authenticity, confirm the amount to be credited or debited, and to insure that a token can be used once and only once and in accordance with the payer's or payee's prescribed parameters. It should be appreciated that, in the implementations described herein, the secured payment account serves to replace other financial accounts (not to provide access to or initiate transactions with other financial accounts of the payer). Likewise, the payment token represents actual currency, such that when generated it has financial value associated therewith and upon transfer to the recipient, no additional transactions with other financial accounts or services are required—the recipient simply needs to present the token to a centralized payment authority to initiate the credit to the recipient's secured payment account and thus effect a funds transfer.

According to various implementations, the systems and methods described in this disclosure employ at least a centralized payment authority (which, as described further herein, may be based at least in part on a centralized postage authority system configured for producing postage transactions, or may in fact utilize such a postage authority system to conduct at least part of the systems and/or methods described herein), a variety of computer-based clients (e.g., mobile devices, personal computers, etc.) to request and render payment transactions (e.g., through a mobile payment application executed on the device, etc.), and a variety of computer-based devices that may receive the payment transactions, such as by a scan, wireless receipt, etc., and initiate authentication of the payment token and/or initiate deposit or otherwise movement of the funds associated with the payment token. These three major components are interconnected through a network, such as the Internet. The payment token may include a digitally-signed data stream, which provides enhanced security for the payment token, including the payment amount (as described in more detail herein). For example, in some implementations, the payment token may be displayed in a 2D barcode format, which is digitally signed for security (which is described in more detail herein), and which can be rendered on a mobile device screen (or printed on hardcopy) for scanning by the recipient. In some implementations, however, a visual display may not be needed. Instead, data transfer may occur from one party to another wirelessly, such as, but not limited to, Bluetooth, Near Field Communication (NFC) protocols, audible tones, wi-fi, infrared, or through other electronic means, such as, but not limited to, https, FTP, and/or other communication protocols. Note that highly specialized equipment such as credit card swipe readers may not be needed to perform the systems and methods described in this disclosure. Technologies which normally have other uses (e.g., scanners, mobile phones) may be re-purposed to handle the transfer of funds and/or perform other secured payment transactions, which increases the flexibility and widespread availability of these systems and methods. The nature of the tokenization, digital signature, and a complete back-end funds transfer/management system sets the systems and methods described in this disclosure apart from existing technologies, e.g., in terms of security and/or ease-of-use. Merchants may potentially save costs for performing secured payment transactions including, but not limited to, funds collection by virtue of a reduced susceptibility to fraud, a lack of requirements for special hardware, and/or other differences with existing payment platforms. In some implementations, merchants could conceivably offer very competitive interchange fees and/or other fees related to secured payment transactions.

In some implementations, resources of a local postal authority (e.g., the USPS in the United States, or other centralized postal authorities) may serve as the centralized payment authority or provide services related thereto, and serve as the holder/guarantor of funds and movement of funds between accounts corresponding to secured payment transactions processed on the system. Doing so would bring to bear the implicit trust and extensive investigative powers of a postal authority. However, in some implementations, a similar system as described herein may be operated independently of the posts, providing a system that includes the architecture and security protocols similar in design and requirements as a centralized postal authority (e.g., USPS) without involving the postal authority. In some implementations, a similar system as described herein may be operated using one or more existing financial institutions, including but not limited to one or more banks. Yet in other implementations, it is appreciated that a hybrid approach may be utilized, such that a third party such as an approved PC postage vendor (e.g., Endicia, Pitney Bowes, etc.) that is configured for transacting at least partially with postal authority postage systems. It is appreciated that any number of combinations or variations with regard to the system architecture, and systems utilized to implement the implementations described herein, may be possible and envisioned by someone skilled in the art and any such alternatives are still within the spirit of this disclosure. It is envisioned that in some implementations, funds may be held, controlled, and/or otherwise managed, at some moment during the process of completing a payment between two end-users, by a financial institution, including but not limited to one or more existing banks.

In some implementations that include a centralized payment authority, this authority could manage transfers from one account holder to another using the systems and methods described in this disclosure. Such a configuration may be likened to a national bank, or other centralized dominant bank, where all parties in a given country have accounts at the same bank. PayPal is a commercial example of this model—all PayPal participants must have PayPal accounts; though, in many PayPal transactions, a second, more traditional financial account is utilized to transfer funds (e.g., credit card charges from payer's credit account to recipient's bank, or ACH check transfer from payer's checking account to recipient's bank).

Alternatively, and/or simultaneously, in some implementations, the systems and methods described in this disclosure may be applied in the case of payment transfers from one financial entity (including but not limited to the centralized payment authority associated with the inventions described herein) to another financial entity (such as a third party financial entity of a payment token recipient). This type of interbank transfer regularly occurs when one writes a check against an account in Bank A and the check is deposited into an account in Bank B. The successful transfer of that check results in a funds transfer from Bank A to Bank B. Credit and debit card transactions work in much the same way. Often the buyer uses a credit card issued by Bank A and the merchant processes that card into his merchant account held by Bank B. So again, funds are eventually transferred from Bank A to Bank B. In accordance with various implementations described herein, this scenario could be accomplished in much the same manner, whereby the payer has a secured payment account with accessible funds (such as a pre-funded/debit account) and the recipient (e.g., a merchant) has a merchant or recipient account that has associated with it a third party financial account or accounts authorized for depositing or otherwise transferring funds thereto by the centralized payment authority. For example, when issuing a payment, upon generating a token the payer's account at the centralized payment authority is debited, and when submitting the received payment token for authentication and credit, the recipient's third party financial account is credited or funds are otherwise transferred thereto by the centralized payment authority. In this manner, recipients may have ready access to funds received by payment tokens without having to rely solely upon the concept of digitized payment tokens issued by the centralized payment authority to liquidate or otherwise utilize received funds.

Implementations of the systems and methods described in this disclosure may be used in a variety of different scenarios, including but not limited to the following scenarios, which are exemplary, and not intended to be limiting in any way:

Scenario 1: Mary visits a clothing retailer/merchant to buy a pair of jeans and a top. She brings here purchase to a sales person and the amount of the transaction is computed to be $45.00. Mary removes her mobile phone from her purse, calls up her payment application and enters her credentials. She examines her account balance and finds she has $350 available. She requests a payment transaction of $45.00 and enters an optional notation that this amount was for her jeans and/or a notation as to the person or entity where the payment is directed. The mobile device then communicates this payment request to the centralized payment authority in a similar way a postage transaction request is transmitted to the USPS. The data returned is a binary payload representing the payment token, and which is displayed in a 2D barcode (or any other barcode) on her mobile phone screen. The 2D barcode is digitally signed by the centralized payment authority using its private key(s), which can be verified using public keys distributable to parties of the transaction. The sales clerk may then scan (or otherwise receive) this barcode. Optionally, an immediate verification of the data stream can be made by using a public key associated with the private key that was used to sign the payment token and distributed by the centralized payment authority. This intermediate verification can be executed by the merchant for immediate determination of whether the payment token is authentic or whether it has been tampered with (which may enable a merchant or other recipient to hold the tokens for offline processing). However, the ultimate authentication and funds transfer to the recipient is accomplished by transmitting the payment token along with the merchant's account number to the centralized payment authority. The authority checks the digital signature, checks against (possibly user-specific) logs to be sure that this is the first request to “redeem” this payment and, if successful, applies the $45.00 to the merchant's account held at the authority. It is possible that the centralized payment authority will likely charge a transaction fee against the merchant's account, similar to the way that Visa/MasterCard, PayPal, and/or other financial service providers do.

Scenario 2: Tom wishes to transfer funds to his son, John, who is at college 2000 miles away. He creates a payment token for $500 (e.g., initiates a payment token request with the centralized payment authority and receives a digitally signed 2D barcode in return, like that describe in the above examples and in more detail herein) and prints it in PDF format (or other image format). In one example, Tom may email the PDF to John. In another example, the payment application executed on Tom's mobile device or PC may be configured to transfer the token directly to John, or to request the centralized authority to transfer the payment token to John rather than to Tom (but likely with confirmation of the same to Tom). John may optionally print the payment token PDF and bring it to the nearest post office, USPS Contract Station, or any other local office or branch operable to redeem secured payment tokens disclosed herein, or otherwise bring a mobile device having stored thereon the payment token. The postal clerk scans the barcode and initiates a redemption transaction with the centralized payment authority (which may in this example be a postal authority) to determine whether it is authentic and not previously redeemed. Upon authentication, John is given $500 in cash (or perhaps $490 and withholds a $10 service fee as a non-limiting example), or crediting John's secured payment account or another third-party financial account. As another alternative, John could scan the payment token PDF himself using an applet linked to his account on his mobile device to initiate a redemption request, and thus transfer the money into his account via the centralized payment authority.

Scenario 3: Jose makes a purchase on an e-commerce web site. The amount of the sale is $55.60. Jose uses his secured payment account to request from the centralized payment authority a secured payment token for this amount, but requests the token in the form of a binary file. The binary file is uploaded to the e-commerce site as a payment option. The e-commerce site optionally validates the data payload by verifying the digital signature using public key(s) distributed by the centralized payment authority, and then submits that binary data stream to the centralized payment authority along with the site's account. The centralized authority authenticates the payment token, checks to be sure that the indicium has not been previously redeemed and, if all checks pass, returns a confirmation code to the e-commerce merchant (and optionally to Jose). This is similar to how credit card verification works but instead of the credit card number, expiration date, security code, and payment address information, the merchant submits a digitally signed payment token which represents the actual funds, and which does not require accessing or processing of another financial account. Moreover, when such a payment token is utilized, the payment amount is fixed and thus less susceptible to fraud or breach due to interception or misuse.

Inputting binary data into a Web page may be problematic. One approach may include a Base64 representation of the binary stream. Base64 is comprised entirely of “printable” characters which can be easily copied and pasted into an input field on a Web page.

Scenario 3 describes an e-commerce web site purchase using the systems and methods described in this disclosure. The (prospective) buyer would access a Web page or client application to access his account with the central authority. The logon and workflow would closely follow the scenario presented on the mobile phone. But rather than a 2D barcode representation of the payment token, the user would be presented with a Base64 text block representing the very same data. He would copy this text block and place it in a receiving text box on the merchant's web site. This would be done in lieu of inputting, for instance, a credit card number, expiration date, CCV2 code, billing address and cardholder name.

The buyer would be motivated to purchase in this way because he would not be giving over their entire credit card and the data input process would likely be quicker. The merchant would be motivated because he does not have to handle or store credit card data which reduces his PCI-compliance burden, and places the merchant at less risk for fraudulent interception of such stored payment data or sensitive payment data utilized in a specific transaction.

The foregoing presents an introductory overview and contextual examples of the payment systems and methods described herein. The following description provides further details regarding various implementations of the systems and methods that may be implemented to support such services.

In some implementations, the systems and methods described in this disclosure implement a secured payment platform. In some examples, the system may support the use of wireless mobile computing devices to perform secured payment transactions. As used herein, the terms “wireless mobile computing device,” “mobile computing device,” and “mobile device” may be used interchangeably, and generally, by way of non-limiting example, refer to a cell phone, a smartphone, a tablet, and/or a handheld computing device. Individual providers may interact with the system through individual computing devices, and/or other means of communication.

As used herein, the individual users of the system may be interchangeably referred to as customers, and generally include payers and recipients/payees. Payers generally refer to individuals requesting and presenting a payment token, but may also include entities utilizing the secured payment system for transacting a payment or other funds transfer. Recipients may be entities (e.g., merchants, retailers, service providers, financial institutions, etc.) or individuals receiving payment or other funds transfer. The system may facilitate interaction between providers. The system and/or any related entities that interact with the system may be deployed using one or more (public) networks and/or commercial web services. The system may facilitate user interaction through client computing platforms, such as mobile devices. Individual client computing platforms may be associated with individual users.

Financial account providers may provide accounts to users, e.g., stored-value accounts, checking accounts, savings accounts, debit accounts, credit accounts, pre-paid accounts, postage accounts, secure payment accounts, and/or other accounts. Examples of financial account providers include banks, credit unions, and the United States Postal Service. Accounts may have a balance. Balances may include points, money, currency, and/or other types of balance.

Users of financial accounts may be individual users (e.g., a customer of a business), commercial users, business users, governmental users, and/or other users. Financial services supported through financial accounts may include bill payments, purchasing in a (brick-and-mortar) store, purchasing on-line (e-commerce payments), obtaining a loan, government-to-citizen payments, use of (open-loop or closed-loop) prepaid cards, mobile financial services, check cashing, and/or other services.

In some implementations, the secured payment account may be provided by and supported on a postal authority's existing postage evidencing systems, whereby the secured payment account is either utilized to process payment transactions exclusively or can be utilized also to process PC Postage transactions (as a real postage account). As used herein, the term “postage account” may include a postage meter account, a prepaid Postal Service account, a PC Postage account, and/or any other account in which at least some of the secured payment transactions are supported by one or more postage evidencing protocols, including but not limited to protocols using information based indicia (IBI). IBI protocols can serve as the basis for secured payment protocols and generating the digitally signed payment tokens, as discussed in more detail herein. By way of non-limiting example, customers of the United States Postal Service (USPS) can obtain a postage account. Alternatively, and/or simultaneously, customers of third-party postage services providers (also commonly referred to as PC Postage Vendors), including but not limited to Endicia®, can obtain an account that supports postage account features, including but not limited to the use of a virtual postage meter to print PC Postage. In some implementations, postage accounts serving as secured payment accounts may be prepaid accounts, which are funded by the account owner in advance of any postage or payment transactions and which are debited upon generation of PC Postage or a secured payment token. In some implementations, some financial services using a secure payment account may be provided at certain (USPS) post offices. For example, a subset of postal offices may support withdrawing cash through the disclosure provided herein, in a manner analogous to the current usage of automatic teller machines (ATMs). As previously mentioned, in other implementations, a secured payment system may instead be implemented without the inclusion or with the limited inclusion of an existing postal authority system, such as an independent centralized payment authority or a centralized payment authority that is also authorized to interact at least partially with an existing postal authority (if included in accordance with some implementations). Transactions involving a secured payment account and/or a postage account may involve postage indicia and/or postage tokens. Generation and/or usage of a postage indicium for postage services have been described in, e.g., U.S. Pat. Nos. 6,005,945, 5,319,562, 7,831,524, and 7,831,518, which are incorporated herein in their entirety. In the field of postage services (which is distinct from the fields of technology relevant to this disclosure), postage indicia may be considered as established and/or proven mechanisms and/or technologies.

As used herein, any association (or correspondency) involving providers, users, and/or another entity that interacts with any part of the system, may be a one-to-one association, a one-to-many association, a many-to-one association, and/or a many-to-many association or N-to-M association (note that N and M may be different numbers greater than 1).

Users and/or providers may interact with the system through client computing platforms. Client computing platforms may include one or more processors configured to execute computer program components. The computer program components may be configured to enable a user associated with a client computing platform to interact with the system, any component thereof, other client computing platforms, and/or provide other functionality attributed herein to client computing platforms. By way of non-limiting example, client computing platforms may include one or more of a desktop computer, a laptop computer, a handheld computer, a NetBook, a Smartphone, a tablet, a mobile computing platform, a cellphone, a mobile computing device, a gaming console, a television, a device for streaming internet media, and/or other computing platforms. In some implementations, client computing platforms may include one or more of an electronic display, a user interface, a transceiver configured to transmit and/or receive information, an interface component, and/or other components.

The one or more computing devices included in the system may include one or more processors configured to execute computer program components. The system may include physical storage, which may be physically located in one location, or may be distributed in different locations, including but not limited to “the cloud”. Computing devices may include servers.

Interaction with the system may be accomplished through web pages, (mobile) applications, apps, stand-alone applications, desktop applications, and/or other types of software applications capable of interacting with a network, for example the internet. As used herein, content provided through any type of software application capable of interacting with a network may be referred to as a web page (including, but not limited to, mobile applications or “apps”).

Web pages may be rendered, interpreted, and/or displayed for presentation using a computing platform, such as a client computing platform. As used herein, displaying information through a mobile application—or app—is included in the term presentation. Presentation of web pages may be supported through a display, screen, monitor of the computing platform, and/or projection by the computing platform. Web pages may be accessible from a local computing platform (e.g., not currently connected to the internet) and/or hosted by a remote web server (e.g., connected to the internet and/or one or more other networks). Web pages may be accessed through a browser software application being executed on a computing platform.

As used herein, mobile applications may be included in the term browser software application. Web pages may be static (e.g., stored using electronic storage that is accessible by a web server), dynamic (e.g., constructed when requested), and/or a combination of both. The browser software application may be configured to render, interpret, and/or display one or more web pages for presentation using a computing platform. The digital content included in a web page may have been provided by one or more content providers. A set of linked and/or organized web pages may form a website. A website may include a set of related and/or linked web pages hosted on one or more web servers and accessible via a network, e.g., the internet. Websites and/or web pages may be accessible through an address called a uniform resource locator (URL).

By virtue of the systems and methods described in this disclosure, a user may, in effect, make secured payments through a client computing platform. The secured payments may be debited from a secured payment account. A payee may receive payments through a mobile device or other computing platform. The payments may be deposited to an account, e.g., a secured payment account. Payments as described herein may be used in various secured payment transactions, including but not limited to purchases in brick-and-mortar stores, e-commerce transactions, online purchases, money transfers, automated teller machine (ATM) transactions, and/or other secured payment transactions.

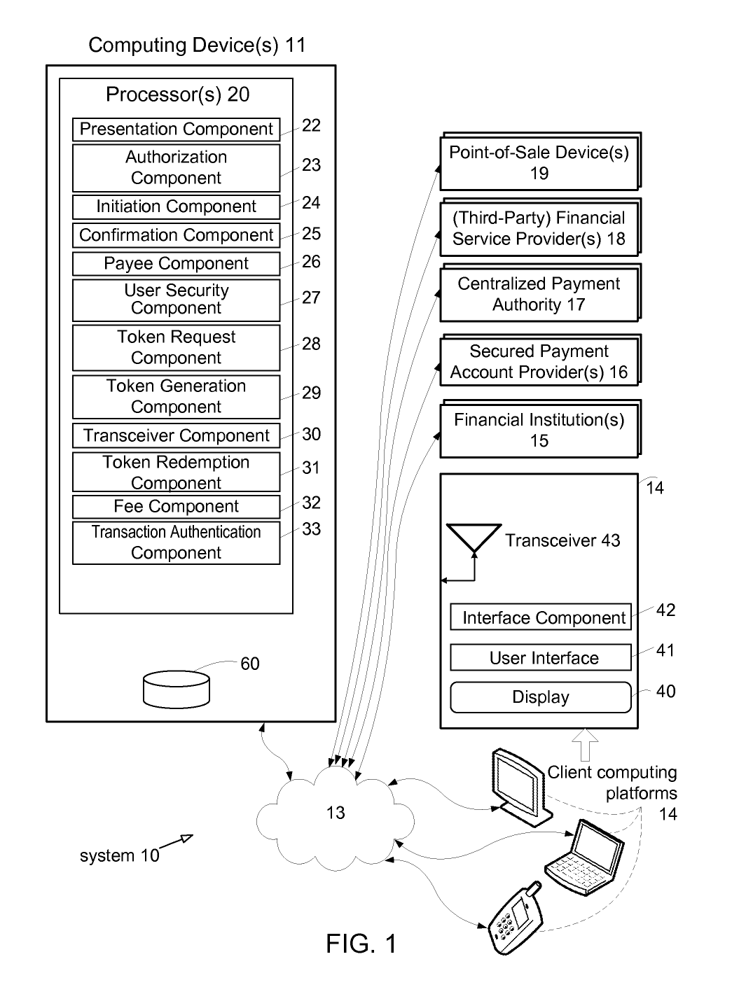

FIG. 1 illustrates an exemplary secured payment system 10 configured to implement a payment platform for users using secured payment accounts as described herein. System 10 may facilitate communication between users and providers, as well as between providers. The providers may include, by way of non-limiting example, one or more secured payment account providers 16, one or more centralized payment authorities 17, one or more third-party financial service providers 18 (also referred to as financial service provider 18), one or more point-of-sale devices 19, one or more financial institutions 15, and/or other entities and/or participants. Users may interact with system 10 through client computing platforms 14. Interaction may be supported by one or more networks 13, including but not limited to the Internet. Any of the services or features that may be provided through this disclosure (including, but not limited to purchases online or in a store, bill payments, e-commerce payments, obtaining a loan, government-to-citizen payments, etc. etc.) may either be provided currently by some business or entity (these may be called providers, such as financial service providers), Alternatively, and/or simultaneously, performing the systems and methods described in this disclosure may, in some implementation, involve a 3^{rd} party to complete the transaction. For example, in-store purchases may involve point-of-sale devices; certain financial transactions may involve a clearing facility; other financial transactions may involve a financial institution such as a bank, etc. Those entities may be jointly referred to as providers.

System 10 may include one or more computing devices 11 (e.g., a server), one or more processors 20, physical storage 60, a user interface 41, an electronic display 40, and/or other components. One or more processors 20 (interchangeably referred to herein as processor 20) may be configured, e.g., by machine-readable instructions, to execute computer program components. The computer program components may include but are not limited to a presentation component 22 (e.g., UI display), an authorization component 23 (e.g., user authorization and/or credentialing), an initiation component 24, a confirmation component 25 (e.g., to send or receive confirmation of secured payment transaction status), a payee component 26 (e.g., to enter payee information), a user security component 27, a token request component 28 (e.g., to initiate secured payment token request from a centralized payment authority), a token generation component 29 (e.g., to generate a secured payment token at the centralized payment authority), a transceiver component 30 (e.g., wireless, wired, audible communication means, etc.), a token redemption component 31 (e.g., to process a request for payment token by a centralized payment authority), a fee component 32 (e.g., to facilitate charging transaction fees, if any), a transaction authentication component 33 (e.g., for authenticating a payment token), and/or other components. The functionality provided by components 22-33 may be attributed for illustrative purposes to one or more particular components of system 10, for example a particular participant. This is not intended to be limiting in any way, and any functionality may be provided by any component or entity described herein, and/or by multiple components. Moreover, while some of the system 10 components described herein may be referenced in the singular or in the plural, it is appreciated that these characterizations are not intended to be limiting and that in other system configurations components referenced in the singular may include more than one of the same components (such as for load balancing, system distribution, and/or shared or divided responsibilities—for example a component may be configured for use by both a user computing device and a centralized payment authority, such as when transacting between the two), and components referenced in the plural may instead include only a single component or instance of the component.

Presentation component 22 may be configured to present one or more attributes of secured payment transactions to users, e.g., using an electronic display of a user's smart phone or other mobile computing device. As used herein, the term “secured payment” may include, but is not limited to, any proposed, planned, expected, prospective, completed, and/or rejected secured payment transactions, as well as secured payment transactions that are in progress. The one or more attributes may include but is not limited to a price, an amount (e.g. a dollar amount), an estimated amount, a description of the goods and/or services that are the object of a prospective secured payment transaction, a date or duration, a name and/or identifier of one or more parties involved in a prospective secured payment transaction, information regarding a secured payment account, secured payment transaction and/or other attributes or information pertinent to a secured payment transaction. Presentations by presentation component 22 may involve one or more of user interface 41 and/or electronic display 40. Presentations by presentation component 22 may be performed on client computing platform 14.

In some implementations, the one or more attributes may include an amount associated with a secured payment transaction. For example, the amount may be an amount to be debited from a user's secured payment account. The amount may be pertinent to a prospective secured payment transaction. For example, the price for a prospective purchase may be presented to a prospective purchaser by a POS or otherwise by a merchant from which the purchase is to be made. For example, a merchant may cause a name and/or identifier of the merchant and/or the merchant's account to be presented to a prospective purchaser. The purchaser may use this presented information in performing a secured payment transaction, e.g., a purchase from the merchant. It is appreciated that in some implementations, merchant information is not required for requesting the generation of a payment token by the user, but instead may be presented, if at all, for the benefit of the payer (e.g., record keeping, etc.).

In some implementations, presentations by presentation component 22 may be performed via one or more of user interface 41, interface component 42, and/or electronic display 40. For example, a user may interact, e.g., via user interface 41 or via a graphical user interface presented through interface component 42, to enter and/or select an amount to be used in a secured payment transaction. Such interactions may include receiving user input and/or selection. User interface 41 may be configured to facilitate interaction with users, for example through electronic display 40. In some implementations, electronic display 40 may include a touchscreen, a touch-sensitive screen, and/or a pressure-sensitive screen.

In some implementations, one or more attributes presented to a user may be obtained and/or received from a client computing platform 14, e.g., a merchant's point-of-sale device 19, or other computing device (e.g., mobile device like a payment tablet, etc.). “Obtaining” as used herein (and derivatives thereof) may be interpreted as active, passive, and/or both.

Presentation component 22 may be configured to effectuate presentation of user-specific information to users. Presentation component 22 may be configured to provide users with access and/or visibility to information at one or more stages of a secured payment transaction. For example, presentation component 22 may be configured such that a user can confirm or deny information that is specific to the user and/or to a secured payment transaction. For example, upon user authentication, presentation component 22 may effectuate the presentation of information appropriate and/or authenticated for that user. The term “appropriate” refers to securing access to user-specific information such that an individual user can only access his personal information, and not the personal information of another user. User-specific information may include, by way of non-limiting examples, a balance of an account, personal information and/or preferences, scheduled and/or completed secured payment transactions, prospective and/or pending secured payment transactions, and/or other information. It is further appreciated that presentation component 22 may be utilized with one or more of the other components, such as to present information or other data corresponding to the functionality of another component described below.

Authorization component 23 may be configured to obtain authorization from and/or otherwise authenticate users. In some implementations, authorization may include authorization to initiate secured payment transactions, such as signing into a secured payment mobile application or signing into a web-based secured payment application. In some implementations, authorization may be implied by a user, for example by one or more particular interactions with one or more of user interface 41, a graphical user interface presented through interface component 42, electronic display 40, and/or other components of system 10. For example, authorization may be implied by virtue of a user clicking on a particular button in a graphical user interface and/or logging in to a software application a priori. Such interactions may include receiving user input and/or selection. In some implementations, authorization may be expressly required from a user prior to one or more steps in a secured payment transaction.

Initiation component 24 may be configured to initiate a secured payment transaction, e.g., a secured payment transaction in which an amount will be debited from a first account (e.g., of a payer user) and/or deposited into a second account (e.g., of a payee user). Initiation may refer to user action, e.g. through a user interface. Initiation may include interface gestures, such as tapping, clicking, swiping, shaking, and/or other interface actions. Initiation may set in motion one or more processes and/or steps that accomplish all or part of a completed financial transaction. In some implementations, the first account and/or the second account may be secure payment accounts. In some implementations, operations by initiation component 24 may include transmissions to one or more providers of financial services, including but not limited to centralized payment authorities 17. In some implementations, transmission by system 10 and/or its constituent components may be supported, performed, and/or provided by transceiver 43, transceiver component 30, and/or other components configured to transmit and/or receive information. In some implementations, one or more particular centralized payment authorities 17 may be associated with one or more particular financial accounts and/or one or more particular types of financial accounts, such as any previously described herein. As used herein, a centralized payment authority 17 may be associated with a particular account if at least some secured payment transactions involving that particular account can be cleared through that particular centralized payment authority 17, and/or if clearance of at least some secured payment transactions involving that particular account may be aided and/or assisted by that particular centralized payment authority 17. In some implementations, initialization may be implied by a user in a similar manner as described elsewhere herein, e.g., by engaging, selecting, and/or activating a user interface element in a graphical user interface.

Confirmation component 25 may be configured to obtain confirmations. Confirmations may be obtained from a centralized payment authority. In some implementations, confirmations may include confirmations, e.g., from centralized payment authority 17, that confirm that secured payment transactions are in a particular stage. For example, confirmation component 25 may be configured to obtain a confirmation from centralized payment authority 17 that a secured payment transaction has been initiated, completed, and/or reached any other stage of progress. For example, a confirmation may confirm an amount having been debited from a particular account and/or deposited to a particular account.

Payee component 26 may be configured to obtain information, including but not limited to identifiers that identify and/or associate with one or more financial accounts, one or more financial account holders, and/or other information associated with one or more parties involved in a secured payment transaction. For example, payee component 26 may be configured to receive, from a merchant, account information for an account of the merchant. As described in more detail herein, one unique example merchant account may include (but need not be limited to) a secured payment account (which may optionally be a postage account), which allows for and/or supports transaction and settlement processes similar to or the same as those utilized for printing and settling PC postage transactions. In some implementations, other components of system 10 may be configured to use the information obtained by payee component 26, such as but not limited to including account information of the merchant in a payment token, as described herein.

User security component 27 may be configured to obtain authentication and/or information used for authentication. Authentication may be obtained from users. Authentication may authenticate users to their respective financial accounts, access to accounts, and/or other types of interaction involving at least some information that a user may wish to remain private and/or confidential. For example, authentication may involve a user providing his username and/or password to system 10. In some implementations, operation of one or more components in system 10 may be conditional on obtaining proper authentication through user security component 27.

User security component 27 may be configured to verify authenticity of payment tokens. This may take place, for example, in the process of payment token redemption. Verification may include one or more of verifying a digital signature of a payment token, verifying that a payment token has not been altered or otherwise tampered with, verifying the account information included in a payment token, verifying the amount represented by a payment token, verifying whether a payment token has already been redeemed, and/or other types of verification related to a secured payment transaction. For example, in some implementations, a payment token may include account information of the user (e.g., a merchant) who is the intended recipient of a payment (through redemption of the payment token). Prior to redemption of the payment token, the target account for the deposit of a particular amount may be verified against the intended account, as a security measure.

Transaction authentication component 33 may be configured to determine and/or verify authenticity, e.g., the authenticity of payment tokens (which are described in more detail elsewhere herein). In addition to authentication, the transaction authentication component 33 may also be configured to conduct a review of the payment token against a data representing used tokens to determine whether the current payment token has been previously redeemed and thus refuse authentication (or payment in essence) if previously redeemed. In some implementations, authenticity may be determined and/or verified at a remote location or system, such as by one or more of financial service providers 18, financial institutions 15, centralized payment authorities 17, and/or other entities described in this disclosure. However, in some implementations, authenticity may be determined and/or verified locally, such as by a merchant POS or any other recipient computing device 14, which may or may not be followed by the need to establish communication and/or a connection with the centralized payment authority.

In some implementations, secured payment transactions involving at least one client computing platform 14 (but possibly involving two or more client computing platforms 14 or mobile devices) include the use and/or exchange of digitally signed secure payment tokens. Payment tokens as the term is used herein refers to a representation of data, which may be secured according to the methods described herein, and which may represent an amount of money. Individual payment tokens may also optionally be designed, intended, configured for, and/or restricted to a specific predefined secured payment transactions (e.g., to a specific recipient and/or for a specifically defined good or service).

In some implementations, a payment token may be designed, intended, configured for, and/or restricted to a single payment, a single use, and/or a single secured payment transaction. Otherwise, without such a limitation a single payment token can be easily exploited by transferring to multiple recipients but only incur a single debit from the payer's account (due to the fact that the token itself is digital currency or otherwise represents live funds which have already been debited from the payer's account). For example, after the first redemption of a particular payment token, the system may be configured to block, limit, restrict, and/or otherwise prohibit any subsequent (attempted) redemption of the same particular payment token. The particular makeup of the payment token, such as being or representing a uniquely serialized indicium, allows for such prior redemption analysis. One-time use payment tokens serve to enhance security and/or decrease risk with respect to conventional payment mechanisms, including but not limited to credit cards, checks, ACH transactions, and/or other conventional payment mechanisms that are more account-based (rather than individual transaction-based as in accordance with the systems and methods described herein) and which can be used to effectuate multiple transactions because they authorize access to or use of an underlying account. In contrast, the secured payment tokens represent the currency itself, and do not require subsequent access to or transactions with a payer's financial account (e.g., credit card, checking, etc.) at any point during the payment or redemption process. In some implementations, verification and/or determination whether a particular payment token has been previously redeemed may include an inspection and/or analysis of the transaction history of the originating secured payment account (i.e., the secured payment account from which an amount is to be debited when the payment token is generated), or an analysis of a transaction history associated with generated tokens, such as but not limited to a redeemed payment token log which may or may not be associated with the payer or the payer's secured payment account. Such transaction logs or other data stores may be maintained in association with a centralized payment authority, or any other entity participating, such as but not limited to a postal authority, etc. Other mechanisms configured to track whether payment tokens have been redeemed are envisioned within the scope of this disclosure.

Payment tokens may include and/or represent information that is digitally signed and thus a secured payment mechanism representing actual currency which is initially debited (or otherwise reserved) from the payer's secured payment account at the time of generation and which can be redeemed at any later time by the recipient without requiring the recipient or the centralized payment authority to initiate any subsequent transactions with the payer's secured payment account, much less any conventional financial account of the payer. The information included in a payment token may include but is not limited to attributes and/or information pertinent to a secured payment transaction and/or secured payment account (including but not limited to an account number for one or more parties involved, token count, one or more names of account holders involved, an amount involved, goods or services to be purchased, date(s), expiration date, time limit, etc.). By way of non-limiting example, a secured payment account may include or have associated or stored therewith, but is not limited to, multiple registers and other information, such as but not limited to a descending register, an ascending register, a control register (other registers may be included or substituted for those described explicitly herein), a meter serial number, a piece count, and/or other information. In some implementations, a secured payment account may include or have associated therewith a token count. The token count may be implemented as a positive integer value that ascends with successive generations of secured payment tokens, and in some implementations may be associated with specific types of transactions. In one example implementation, a payment token may include a combination of the originating (payer's) secured payment account number (or other unique identifier) and the token count for that account that is associated with a particular secured payment transaction. In some implementations, such a combination may be used to identify uniquely an individual secured payment transaction and/or the specific payment token generated. In some implementations, the payment token may include the token count.

Payment tokens may be virtual, e.g., an electronic file in a particular format. In some implementations, payment tokens may be represented by a sound, a sequence of sounds, an image, a video, an animation, and/or any other format suitable to transfer and/or exchange information, including combinations of multiple formats. Payment tokens may alternatively be implemented and/or formatted in a physical representation, e.g., by printing pertinent information included in a payment token on a piece of paper. In some implementations, a payment token may be digitally signed for enhanced security. For example, payment tokens may include one or more digital signatures such as, by way of non-limiting example, digital signatures that are signed by the centralized payment authority by a private key (known only to the centralized payment authority), and verifiable using a public key (which can be distributed to one or more participating parties having the need to conduct an signature authentication operation). It is appreciated that any number of signature techniques may be exercised by one having skill in the art, and remain within the spirit and the scope of the systems and methods described herein. By digitally signing the payment token, the payment token data may be easily discernable (if not itself encrypted, which is not required), but the integrity of such data can be verified by any party that has the public key. Thus, a recipient may be able to read or otherwise interpret the payment token's content (such as to verify the payment amount, etc.) without having to decrypt or authenticate the signature, allowing the recipient (or the payer) to verify the payment token's content. Digital signatures may be based on, by way of non-limiting example, digital signature algorithm (DSA) technology, RSA technology, and/or other cryptographic signature systems or techniques. It is appreciated, also, that in some implementations, payment tokens (or parts thereof) may be encrypted for further protection from illegitimate use or access to information contained therein.

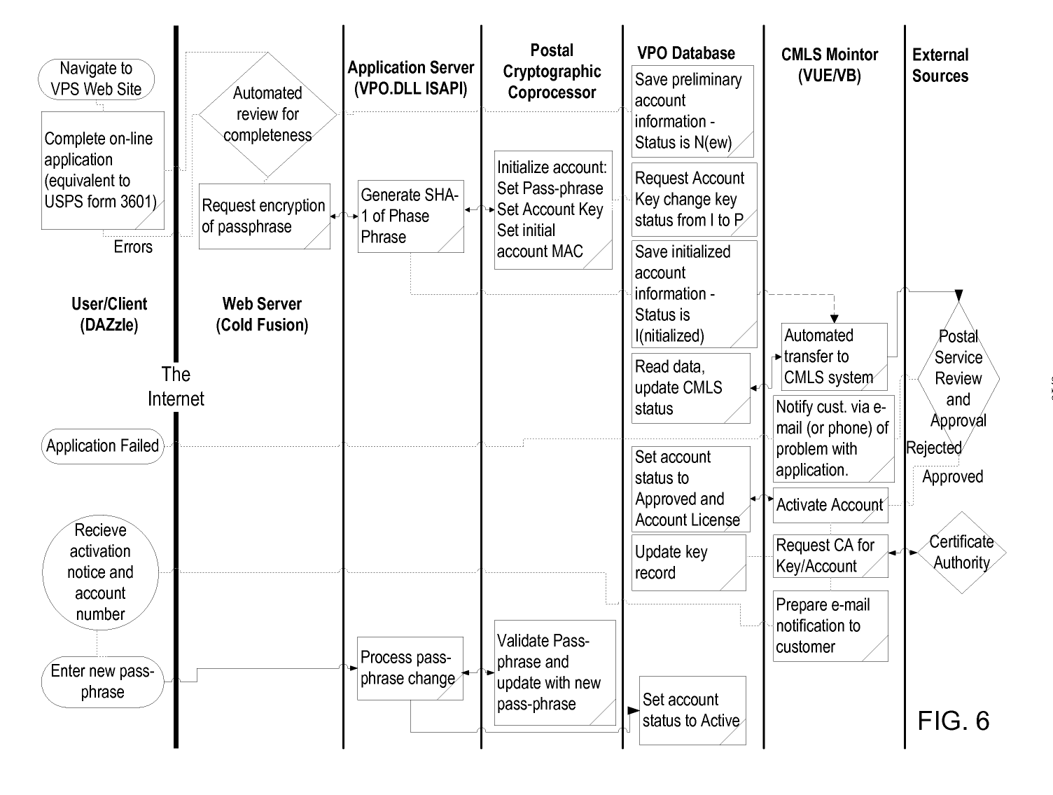

In some implementations, a payment token issuing system may use an optional double encryption methodology based at least in part on postage indicium and postage evidencing protocol (e.g., by or in conjunction with the USPS). Most of the information included in a payment token may be encrypted with the public component of an RSA messaging key pair, and decrypted using the corresponding private key. Some of the information, for example the originating account number may remain unencrypted and/or in the clear. The encrypted information may be doubly encrypted with an SSL tunnel and transferred to, e.g., a receiving computing device at the centralized payment authority. The receiver may collapse the SSL tunnel and in doing so may expose the originating secured payment account number. Additional exemplary details of the payment token issuing system are illustrated in the flow diagram of FIG. 6.

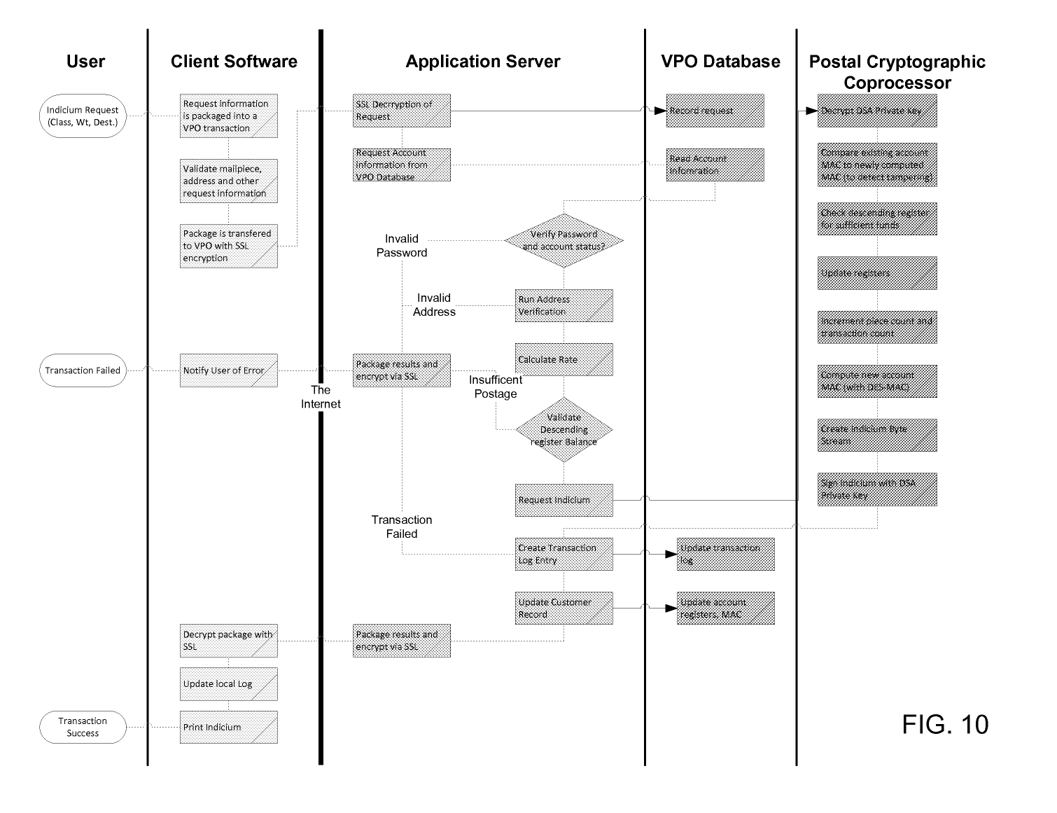

By way of illustration, FIG. 6 and FIG. 10 illustrate flow diagrams of a payment token issuing system in accordance with one or more implementations. FIG. 6 illustrates, at least and by way of non-limiting example, steps that may be used when singing up a new account for a payment system or payment platform. FIG. 10 illustrates, at least and by way of non-limiting example, steps that may be used when generating a payment token. The issuing system may use FIPS-140-1 Level 3 and FIPS-140-1 Level 4 protocols, which require that all authenticated communications to the secure device be identity-based. According to these protocols, the authentication process must involve a decryption operation within the confines of the secure environment, and any key material (or related Security Relevant Data Items—SRDI) must be encrypted as it is passed from the host into the secure device since this port is shared.

The messaging model illustrated in FIG. 6 and FIG. 10 meet all of the foregoing requirements. With the exception of two calls, all VPO API calls use public/private key protocols for encryption and decryption. Specifically, 1024 bit RSA key pairs are employed. The exceptions to this rule are two functions that will be discussed in ensuing sections: One of them is used in manufacturing, and the other used to initially gain control of the secure device post manufacture.

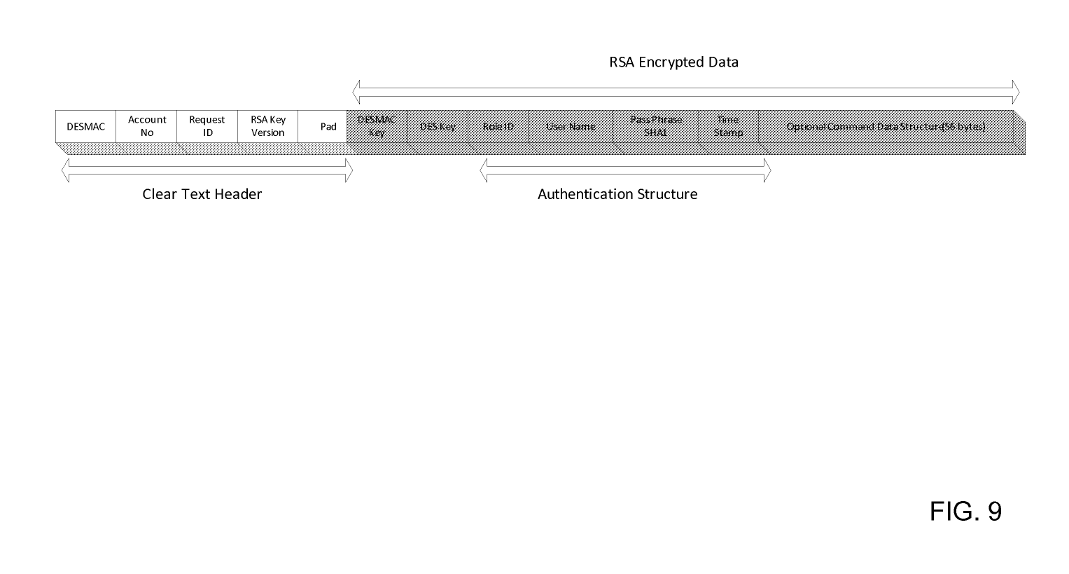

FIG. 9 illustrates an exemplary message structure used to request a payment token. The message structure features a “clear” header 24 bytes in length, followed by an RSA encrypted data stream of 128 bytes in length. RSA public key encryption is typically used to encrypt symmetric key material that is subsequently used to encrypt and transfer large amounts of data. The SSL3 protocol is a common example of using RSA public/private key operations to exchange key material for subsequent symmetric data encryption.

This message structure includes command messages that need to be transferred from the host software to the secure device and that are relatively short in length. In addition to key material, the RSA public key encryption operation also encrypts authentication data (username, pass phrase, role ID), as well as command-specific data (such as payment token request data). This approach not only offers superior encryption strength (1024 bit vs. typically used 128 bit symmetric encryption), but also permits messages to be sent with minimal transmission overhead. Rather than establishing a “session” or “dialog” between the client and the “postal cryptographic coprocessor” (shown in FIG. 6 and FIG. 10), a single encrypted message (including authentication) is sent to the postal cryptographic coprocessor and a single reply is sent back to the client. Examples of cryptographic coprocessors include, but are not limited to, the 4758 and the 4764 IBM coprocessors. In some implementations, other highly secure cryptographic coprocessors that meet, e.g., Federal Information Processing Standard (FIPS) Level 4 standards may be used.

The details of the incoming message structure can be seen in FIG. 9. The 24-byte header contains a DESMAC on the entirety of the message, the account number, a request ID (indicating the VPO function being requested), and the version of the RSA key being employed for the encryption/decryption. All of this material is “in the clear” as it must be interpreted (but not changed) by the application server's ISAPI gateway function prior to routing this command into one of the application server-based postal cryptographic coprocessors. The clear text request ID is often used to read supporting account or key data from the SQL databases, so that information can be concurrently passed to the postal cryptographic coprocessor with the encrypted command message. This clear text header poses no security risk, as it contains no SRDI.

The RSA-encrypted portion of the message is comprised of a randomly generated DESMAC key, a similarly generated DES key (which is actually not used in the current design), an authentication structure (comprised of user name, SHA1 of user pass phrase, role ID and timestamp), and optionally, a command-related data structure of up to 54 bytes in length.

Every message features inherent randomness (introduced by the combined effects of the DESMAC key, the DES key and the timestamp in the authentication structure). The message entropy is often further increased by randomness in the command-related data structure.

Referring to FIG. 6 and FIG. 10, the application server then retrieves all the associated data for that account along with the account MAC and passed that data—along with the still encrypted request—into the cryptographic card. The card uses the secret RSA private message key to decrypt the message. The message itself contains a DES key and DESMAC, so those values are used to confirm that the decrypted message has not been altered and/or garbled. If all the checks pass, the balance is checked against the amount requested to confirm that sufficient funds do exist. If so, the descending balance is decremented, the ascending balance in incremented and the piece count (alternatively referred to herein as the token count) is increased, e.g., by one. The co-processor assembles the response message and may digitally sign it with the DSA private key, e.g. by appending the digital signature to the payload of response message. In some implementations, at least part of the payload may intentionally remain unencrypted, such that users may verify, e.g. by using a public DSA key, that the payload has not been tampered with (in addition to verifying who created the payment token). This payload is then emitted from the card and returned to the remote caller via https/SSL. The above description is the preferred embodiment and one skilled in the art will recognize there are subtle variations one might use to accomplish the same tasks but would fall within the scope of this disclosure.

Existing postage systems use the indicium payload to create a mailing label or stamp. As discussed previously—in the context of this disclosure—the payload is instead designed to be transferred to another secured payment account. There are a variety of ways to do this. By way of non-limiting example, one could perform the indicium request (or payment token request) using a mobile app and then display a 2D barcode representation of the payload on the mobile screen. This barcode could be scanned by a receiving party directly from the screen. Alternately, the 2D barcode image could be sent to another party as an SMS message or via email. It could be printed on hardcopy for subsequent scanning by the accepting party. Or it could be transferred as a binary data stream from one mobile device to another mobile or desktop computer. It could be uploaded to a Web site as the shopping cart is accepting payment. It could be transmitted to another nearby device via Bluetooth, Near Field or other preferable secure short range transmission protocols.

This represents a significant departure from the end-use of a postage indicium—which is always printed and then inducted in the Postal operations environment for physical transfer from one location to another.

In some implementations, binary data included in payment tokens may be formatted and/or represented as an American Standard Code for Information Interchange (ASCII) string, a (two-dimensional) barcode, and/or another standardized format. A non-limiting example of a format used for payment tokens using an ASCII string is the BASE64 format. The use of payment tokens may be based on (but need not be limited to) postage evidencing protocols. During secured payment transactions, the format of payment tokens may be changed and/or converted while maintaining the pertinent information needed to verify the authenticity of the payment tokens and/or redeem the payment tokens.

Referring to FIG. 1, token request component 28 may be configured to receive a token generation request from a user. Token generation requests may authorize (at least part of) a particular secured payment transaction. For example, a token generation request may authorize a particular amount to be debited from the payer's secured payment account (also referred to herein as the originating account). In some implementations, the payer user (and/or other user) may contact a server to request a payment token. The server would receive such a request.

According to one implementation, a token generation request also initiates the actual generation of payment tokens, which may have associated therewith particular token or payment attributes. For example, a token generation request may result in the generation of a payment token that is redeemable by the recipient for a particular amount, and as a result of this generation request the payment amount (and optionally any additional service fee, as discussed herein) is either debited directly from the payer's account at that time or set aside or reserved for subsequent debit/settlement.

Token generation component 29 may be configured to generate payment tokens in accordance with token generation requests (e.g., as obtained by token request component 28), which may optionally have associated therewith particular attributes. For example, token generation component 29 may be configured to generate a payment token that represents a particular value and/or amount, or that is redeemable for a particular amount. In some implementations, payment tokens may be generated by a server, and subsequently transferred to a user. In some implementations, generated payment tokens may include information pertinent to a specific secured payment transaction, including but not limited to a name and/or identifier of one or more parties involved in a prospective secured payment transaction, information regarding a secured payment account, a secured payment account number and/or account identifier of one or more parties involved in a prospective secured payment transaction, and/or other attributes or information pertinent to a prospective secured payment transaction as would be appreciated by one having skill in the art. In some implementations, token generation component 29 may be configured to verify whether the payer's (requestor's) secured payment account has sufficient balance such that the value requested for the particular payment token can be debited from the secured payment account in conjunction with the generation of the particular payment token. In some implementations, token generation component 29 may be configured to debit a particular amount (e.g., the amount represented by a particular payment token) from a particular account in conjunction with the generation of the particular payment token. In some implementations, debiting a particular amount may be replaced by making that amount temporarily unavailable to the account holder.

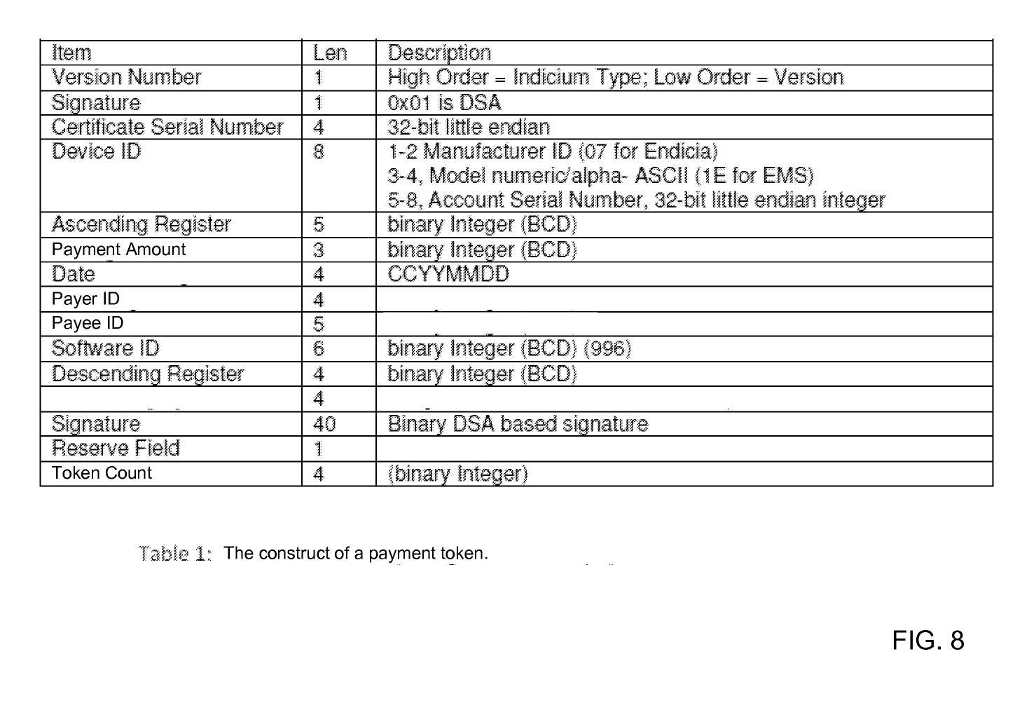

By way of illustration, FIG. 8 illustrates a table that includes an exemplary construct/format of a payment token as may be used in one or more implementations of the technology described in this disclosure, such as a payment token based at least in part on a postage indicium and associated postage evidencing protocol. The fields depicted in FIG. 8 are self-explanatory. It is appreciated that one skilled in the art will appreciate the ability to substitute or alter one or more fields of the token structure shown in FIG. 8 for a particular implementation. It is appreciated that one skilled in the art will appreciate that one or more fields traditionally used in a postage indicium may have no corresponding utility in performing a secure payment as described herein, and that such fields may thus be removed and/or re-purposed. All or some of the fields may be digitally signed prior to usage and/or transmission, some or all of which may optionally be encrypted as well. One or more fields may be specific and/or proprietary for a particular implementation, e.g., as used by a particular centralized payment authority.

Transceiver component 30 may be configured to transmit and/or receive information, including but not limited to payment tokens. For example, transceiver component 30 may be configured to transmit payment tokens to one or more client computing platforms 14. For example, a client computing platform associated with a particular user (e.g. a payer user and/or a payee user). The transmitted payment token may have been generated by token generation component 29. Once a user has received a payment token, a user may present, exchange, transfer, and/or otherwise cause the payment token to be available to another user, for example a payer transmits the payment token to a merchant to effect a secured payment transaction. In one example, the user may transfer the payment token via one or more communication protocols, including but not limited to text message, email message, Bluetooth, near field communication (NFC), iBeacon™, radio frequency (RF) based communication, and/or other means of (digital and/or electronic) communication. Sound-based communication and/or other forms of communication are envisioned within the scope of this disclosure. In some implementations, the payer may print the payment token on a piece of paper and present the paper to a recipient, such as a merchant, for scanning and/or processing otherwise. In some implementations, transceiver component 30 may be configured to receive payment tokens, e.g., from a merchant. Transmissions in system 10 and/or external to system 10 may be secured and/or encrypted, e.g., through secure sockets layer (SSL) technology, transport layer security, and/or other mechanisms. In some implementations, a user may be able to request re-issuance and/or re-transmission of a previously generated payment token (which in one example may be limited to payment tokens that have not yet been redeemed to avoid fraud). In some implementations, to increase the security and reduce the risk of fraud, redemption of a particular payment token may be limited to one time, notwithstanding the number of issuances and/or transmissions.

Token redemption component 31 may be configured to obtain token redemption requests, e.g., in conjunction with token redemption requests. For example, token redemption component 31 may be configured to obtain, from a payee user, a token redemption request that includes a particular payment token that is redeemable for a particular amount. For example, a payment token may be used for a secured payment transaction involving a payer user (e.g., a customer paying for a purchase of one or more goods or services from a merchant) and the payee user (e.g., a merchant). The payment token obtained from the payee user may be based on the payment token that was generated by request of a payer user. In some implementations, redemption of a payment token may be conditional on verification and/or authentication of one or more attributes of the payment token.

Token redemption component 31 may be configured to redeem payment tokens, such as by depositing the amount represented by the payment token into a secured payment account associated with or otherwise designated by the payee user (e.g., a merchant). In some implementations, token redemption component 31 may be implemented on a server. The secured payment account used for redemption of a payment token (through a deposit by the centralized payment authority) may also be referred to as a target account, a recipient's account, and/or a payee user's account. It is appreciated that the secured payment account serving as the target account is, in one example implementation, a secured payment account with the centralized payment authority. It is further appreciated that in some example implementations, additional settling of or disbursement of funds from (and/or into) a secured payment account of the centralized payment authority may be made into (and/or from) a conventional third-party financial account (e.g., credit card account, checking account, savings account, etc.), and in some implementations may be moved between other secured payment accounts of the centralized payment authority.

In some implementations, payment tokens may be rescinded, revoked, and/or otherwise prevented from redemption prior to actual redemption attempts. In some implementations, redemption may be prevented in cases and/or scenarios similar to a “stop-payment” as may be used, for example, for checks. The systems and methods described in this disclosure provide for rescinding a token if it has not yet been redeemed. This may be done by the payer user sending an authenticated message to the central authority along with, e.g., the serial number of the token or other unique identifier of the payment token or original token generation request, etc. In some implementations, revocability of a payment token may be requested at the same time as a token generation request. In such a case, revocability may be indicated in the generated payment token, e.g. by setting a flag or a field of the payment token to a particular value. Once the revocation command is received, any subsequent attempt to redeem the token will be rebuffed, such as by updating a transaction log associated with the payer user's secured payment account, or a token log which may or may not be associated with the secured payment account, in much the same manner redemption verification would ordinarily be conducted, as described elsewhere herein.

In some implementations, certain recipients of the payment tokens may require that a “stop-payment” operation cannot be undertaken by the buyer. This may be accommodated by a flag in the payment token (which a recipient can verify prior to accepting the payment token and/or prior to an attempt to redeem the payment token) data payload that would be enabled or disabled by the buyer depending on the circumstance as appropriate and/or required. In implementations that allow a payer user to revoke a payment token after the token has already been generated without setting the corresponding flag, the particular flag in the payment token may not be dispositive, to a prospective recipient, in determining whether the payment token can be revoked and/or is revoked. It is envisioned that someone skilled in the art may implement combinations and variations with regard to the protocols and features governing revocability of a payment token such that, in some implementations, recipients may have the ability to require and/or verify that a payer user (or buyer) cannot undertake a “stop-payment” operation as described herein. For example, in some implementations, a payer user may be limited to a single opportunity to set or alter whether a payment token is revocable or not, and a recipient may have the ability to verify both the status of the revocability of a payment token, as well as whether the payer user has an opportunity to set or alter that status.

In some implementations, payment tokens may be reissued. The systems and methods described in this disclosure support remedies to misprints or lost payment tokens, such as via data transmission errors. The systems and methods described in this disclosure permit a re-issue of an un-redeemed payment token to the payer user who owns the originating secured payment account (i.e., the payer). According to one implementation, a payer user may identify payment tokens to be reissued by reviewing recent transactions, such as via a Web site or within the a mobile application in communication with the centralized payment authority, or in a local application log, such as may be maintained in a mobile or local application of the payer user. In some implementations, the account holder must authenticate himself once again to access this functionality so as to avoid reissuing to the wrong user or if someone has physically gained control of the account holder's mobile device, computer, etc. Moreover, the centralized postage authority will not re-issue a payment token that has already been redeemed. (Notwithstanding, even if the system did re-issue a redeemed payment token, it would be useless because when a second attempt is made to redeem it, the transaction would be refused under the prior redemption verification routines performed.)

In some implementations, issues involving unused or misplaced payment tokens may be remedied. For example, when a signed payment token is prepared, the amount of the transaction may be immediately deducted from the source account. The payment token might take the form of an email attachment, a printed barcode on a piece of paper, a stored data file on a computer or mobile device, and/or other forms/formats. This payment token is essentially awaiting a “redemption” which will inject the associated funds into another account on the system.

There may be cases where this payment token is lost or forgotten. In accordance with one example implementation, there is provided a way to recover these funds represented by the payment token and to return them to the originating secured payment account. Recovery or return may be accomplished by voiding a transaction, for example—something that can be done by the originator/payer or high level administrator of the centralized payment authority. Since each payment token may have a unique identifier and/or combination of identifiers (for example including a secured account number and token serial number as described herein), the voiding process updating a log or database record so that future redemption attempts for the unique payment token will always be rejected. After the void status is established in the system, the original funds can be returned or credited to the originating secured payment account. Thus, unlike lost cash currency, these payment tokens can always or almost always be recovered.

In some implementations, the systems and methods described in this disclosure may support recurring payments. Note that conventional credit cards may be stored and used for recurring charges such as cable bills, mobile phone usage, and/or other recurring payments. But credit cards and similar payment systems may be vulnerable to massive data loss by ever present hackers. The systems and methods described in this disclosure invention may support recurring payments, e.g. through payment automation. For example, a user-configurable “payment manager” application (e.g., web-based or mobile device application) could be used. The payer user would enter one or more payment entities, such as a phone service provider to provide an illustrative example. The phone service provider would provide its secured payment account number with the centralized payment authority for funds deposit as described in this disclosure. Monthly, the phone service provider would communicate to the payer user a request for a certain amount to cover phone charges. The payer user could receive this request on their computer or mobile device. The payment manager would be configured to permit confirming that the requestor was in the list of user-defined vendors who have been pre-authorized for payment (e.g., they have a secured payment account with the centralized payment authority and optionally have designated the account as being capable to receive recurring payments). Either automatically, or with an explicit approval from the payer user, the payment manager application would cause the generation of a payment token for the amount requested. In some implementations, the digitally signed token could also include the account number of the phone service provider.

The payment token would be transmitted to the phone service provider by the payment manager (or alternatively queued for manual transmission initiated by the payer user). The phone service provider would forward that payment token for redemption at the central authority. The central authority would verify the digital signature, confirm that this payment token had not been used previously, and then deposit the funds into the phone service provider account. This last communication step may be similar to what the phone service provider would do with credit card information on file, but using a different Web service managed by the centralized payment authority that uses exclusively the secured payment accounts therewith. It is further appreciated that in some recurring payment implementations, the recipient (e.g., the phone service provider in this illustrative example) need not receive the token prior to redemption, but instead may simply receive confirmation of the automated payment via the payment token, whereby the centralized payment authority internally authenticates and redeems after generation in accordance with the pre-defined recurring payment schedule. This is possible in large part because there are not multiple financial institutions involved—the centralized payment authority serves effectively as the payer user's bank and the payee user's bank.

In some implementations, the systems and methods described in this disclosure may support conversion of a payment token to cash. There may be occasions when the recipient of a payment token doesn't want to redeem the payment token by depositing it in an account. The systems and methods described in this disclosure may support an option flag in the digitally-signed payload of a payment token which indicates if this transaction can be redeemed for cash. If this flag is set, it will be possible to present the payment token in a variety of formats (e.g. 2D Barcode, Bluetooth data feed, etc.) to a participating bank, post office, auto teller, and/or other provider of financial services (which are participants and have a secured payment account with the centralized payment authority), and receive a cash equivalent for the payload amount represented by the payment token. A service fee might or might not be applied. In this way, the originator of the payment can add an additional level of security by requiring the payment to be redeemed into another account (say a tax payment to IRS) and disallowing a cash option which may be inappropriate for some circumstances, e.g. a tax payment.

In some implementations, the systems and methods described in this disclosure may support adding funds to a secured payment account (also referred to herein as pre-funding the secured payment account, because it serves as a debit account). In some implementations, a secured payment account may be replenished by sending funds to the centralized payment authority. Wire transfers, ACH, credit card transactions, mailed checks, cash deposits, and/or other forms of payment may be used, and may have associated costs (e.g. credit card transactions might have a 3% fee plus a 20 cent flat fee). The systems and methods described in this disclosure support the centralized payment authority (which may mean a postage vendor in some implementations, or any other provider of centralized payment authority services as described in this disclosure) to position itself as a competitor to the credit card industry and/or commercial banks. Depositing funds into an account used for secured payment transaction via relatively expensive channels (i.e. credit cards) may not be preferred due to the fees incurred. In some implementations, the centralized payment authority might take the position that cash deposits at a local branch (e.g., a local post office if the postal authority services as the centralized payment authority) or inexpensive ACH transactions will be the preferred way that “outside funds” can be added to an account. Once these funds are transferred via these inexpensive channels, the account holder can start to make purchases and transfer funds to other secured payment accounts with the centralized payment authority. For example, if using postage accounts as the secured payment account with a postal authority as the centralized payment authority, there is an audited transaction type (seldom used currently) which allows a funds transfer from one (postage) account to another. Operationally, there may be virtually zero cost associated with such a transfer as it is simply a value transfer from one account row to another—brokered by a secure cryptographic card and recorded in a transaction file. Likewise, similar internal transfers between secured payment accounts at a centralized payment authority (if not a postal authority) may also experience such low or zero cost with the transfers, which provides the overall opportunity for this payment vehicle to become quite cost-competitive versus conventional payment methods.

In some implementations, the systems and methods described in this disclosure may support secured payment transactions in which one party has a secured payment account with the centralized authority and one party does not. For example, in some implementations, redemption of payment tokens may be supported to other types of account and/or cash. In some implementations, payment tokens may be redeemable for cash. For example, a recipient of a payment token may be able to redeem a payment token for cash at a participating bank, certain (USPS) Post Offices, and/or other financial service provider that do have secured payment accounts and are registered with the centralized payment authority.

Fee component 32 may be configured to charge users transaction fees, including the payer user and/or the payee user, such as but not limited to fees associated with one or both of the generation and/or redemption of payment tokens. In one implementation, these fees are to be retained by the centralized payment authority, and deducted from the debit and/or the credit transactions to the payer user's account and the payee user's account, respectively. It is appreciated, however, that any number of participants may likewise be charged or provided a fee payment.

In some implementations, payment tokens may be redeemable only for a limited time. For example, a payer user may determine and/or select a time limit, time window, and/or other duration such that redemption of a particular payment token is allowed for a limited time and not allowed after expiration of the limited time. Such time limitations may provide increased security by limiting the possibility of interception and/or other fraud to the time period in which a payer user expects to use the token (and/or expects the token to be used). Time limitations may be set by a payer user and/or payee user, configured separately for each new token generation or set as a default for all applicable tokens generated, or in other implementations may be set automatically by the centralized payment authority.

In some implementations, transceiver component 30 may optionally be configured to transmit an indicator to a client computing platform 14 associated with a particular user, such as the payer user. The indicator may indicate a request to the payer user to confirm redemption of a particular payment token that was generated by request of the particular user prior to its redemption. Confirmation component 25 may be configured to obtain and/or receive a confirmation from the particular user (e.g., the payer user). In some implementations, confirmation component 25 may be implemented by the same server that is configured to redeem the payment token. Redemption of the particular payment token (by a different user, e.g., a merchant) may be conditional on confirmation of the particular user. Such optional confirmations may provide increased security, giving the payer user an opportunity to review and/or authorize a payment prior to redemption, and thus providing an opportunity to decline any transactions that were not initiated by the user (e.g., fraudulently generated transactions), and/or for transactions which the user no longer desires to be completed.

In some implementations, secured payment transactions using payment tokens as described in this disclosure may be used for interbank transfers. In some implementations, secured payment transactions using payment tokens as described in this disclosure may be used for peer-to-peer payment services and/or systems. By way of non-limiting example, the following scenario describes transactions between banks:

Interbank transfers regularly occur when a user writes a check against an account in Bank A and the check is deposited into an account in Bank B. The successful transfer of that check results in a funds transfer from Bank A to Bank B. Credit and debit card transactions work in much the same way. Often the buyer uses a credit card issued by Bank A and the merchant processes that card into his merchant account held by Bank B. So again, funds are eventually transferred from Bank A to Bank B. Both of these transfers traditionally employ vulnerable technologies that have features that need to be improved upon.

Bank A could set up an operating environment similar to the centralized payment authority system described herein (e.g., similar to a postage evidencing system). That is, Bank A could generate its own public/private key pair and use the private key to digital sign payment tokens. Account holders at Bank A could use the technologies described in this disclosure to request a payment token for a given amount drawn on Bank A. This token could then be transferred to another party (e.g. a merchant) who would, in turn, transfer this token to his bank—Bank B. In this case, the token payload would not only contain the amount of funds, but a unique identifier to Bank A (for instance the bank's routing number).

The merchant's bank receiving this token may or may not have a similar token creation service, but it can nonetheless accept and process the payment token from Bank A. Recall that the data in the token may be not encrypted but rather may be accompanied by a digital signature. So Bank B can easily read the amount of payment and the issuing bank's identifier. Optionally, the token might contain the merchant's account number at Bank B. But now Bank B must determine if a) this is a valid token issued by Bank A and b) if this token has been redeemed already.

Bank B can determine the authenticity of the token by using the freely-distributed public key of Bank A. This may be not a required step because Bank B must eventually communicate the token contents to Bank A for redemption and that check will be performed by Bank A as well. In some implementations, this communication may be performed via a secure standardized request (e.g., XML) to a Web service operated by Bank A. The request would contain Bank B's identity and authentication credentials.

Bank A would authenticate the token by using its public key and also checking the transactions logs for the buyer's account. Bank A would also confirm that the token had not previously been redeemed. In some implementations, Bank A may verify that the token had not expired or been voided by the issuer. Once all these checks were completed successfully, Bank A would transfer funds to Bank B using the same processes it normally uses to when checks or credit card transactions are processed.

Accordingly, the digitally-signed payment token described in this disclosure may be employed by conventional banks, credit unions, and/or other financial service providers to enhance security and/or reduce vulnerabilities in fund transfers.

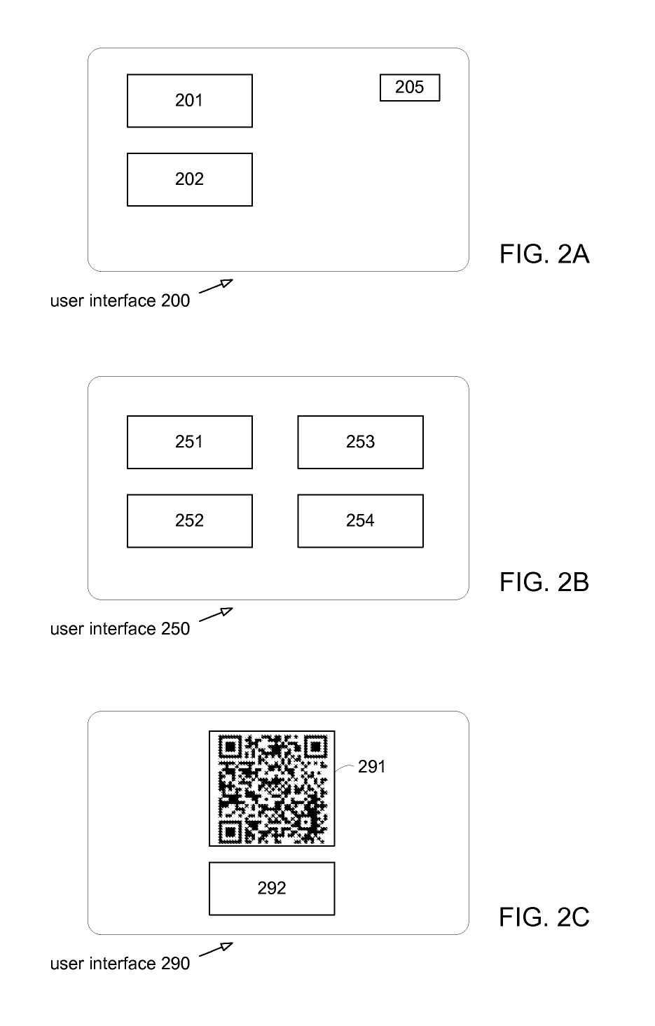

By way of non-limiting example, FIGS. 2A-2B-2C illustrate exemplary graphical user interfaces 200, 250, and 290 as may be used to present information to one or more users and provide interaction between the users and a system as described in this disclosure. Graphical user interface 200, such as may be presented on a mobile device (e.g., smart phone, tablet, etc.) or any other computer-based device, may include user interface elements, including but not limited to action elements 201 and 202, and element 205, and/or other elements. Action element 201 may present a user-selectable option to a payer user, e.g., to create a payment (upon selection). Action element 202 may present a user-selectable option to a payee user, e.g., to receive a payment (upon selection). Element 205 may be used to cause and/or initiate other steps as described in relation to secured payment transactions in this disclosure.

Upon selection of action element 201 in FIG. 2A, user interface 250 in FIG. 2B may be used to present information to users and provide interaction between the users and a system as described in this disclosure, such as to request the generation of a payment token by a payer user to be used in a secured payment transaction. In FIG. 2B, graphical user interface 250 may include user interface elements, including but not limited to entry elements 251, 252, and 253, and action element 254, and/or other elements. For example, entry element 251 may be used to enter and/or select (responsive to user input) an amount to be transferred by a new secured payment transaction, e.g., through a payment token. Entry element 252 may be used to enter and/or select (responsive to user input) a destination for the secured payment transaction, e.g., the payee user, and/or information that identifies a secured payment account and/or an accountholder. In some implementations, use of entry element 252 may be optional. Entry element 253 may optionally be used to enter and/or select (responsive to user input) an expiration date for a newly generated payment token, as described elsewhere herein. Action element 254 may present a user-selectable option to a payer user, e.g., to request generation of a payment token having the attributes as reflected through entry elements 251, 252, and 253 (upon selection of action element 254 by a user). Such a request for generation may be received by a token request component as described elsewhere in this disclosure.

Upon selection of action element 254 in FIG. 2B, user interface 290 in FIG. 2C may be used to present information to users and provide interaction between users and a system as described in this disclosure, such as to present a received payment token for redemption by a payee user in a secured payment transaction. In FIG. 2C, graphical user interface 290 may include user interface elements, including but not limited to elements 291 and 292, and/or other elements. In some implementations, element 291 may be used to present a newly generated payment token (which may be received from a transceiver component and/or generated by a token generation component as described elsewhere herein), such as via the user interface 290. In some implementations, element 291 may present a two-dimensional barcode that represents a payment token via the user interface 290. Other formats to represent a payment token are envisioned within the scope of this disclosure. Element 292 may present one or more user-selectable options to users, e.g., to present or transmit the payment token presented using element 291. For example, element 291 may actually present or display the payment token (e.g., 2D barcode) via the user interface 290 so that another user, e.g. a payee user, can scan or photograph the payment token represented by element 291 (e.g., via a barcode scanner, camera, etc.). In some implementations, element 291 may permit presenting the payment token via other means, such as but not limited to via text message, email message, Bluetooth, and/or other means of (digital and/or electronic) communication or sound-based communication.

Upon selection of action element 202 in FIG. 2A, user interface 290 in FIG. 2C may be used to present information to users and provide interaction between users and a system as described in this disclosure, such as to receive a payment token from a payer user by a payee user in a secured payment transaction wherein the payee user is using a similar mobile device or another computing device having a user interface. In FIG. 2C, graphical user interface 290 may include user interface elements, including but not limited to elements 291 and 292, and/or other elements. In some implementations, element 291 may be used to obtain and/or receive a payment token, for example by scanning a displayed and/or printed payment token. As depicted in FIG. 2C, a payment token may have been scanned (or a photo taken thereof) and element 291 may present and/or reflect the scanned image. Element 292 may be an action element that present a user-selectable option to a payee user, e.g., to request redemption of the (scanned) payment token reflected and/or presented by element 291. Such a request for redemption may be received by a token redemption component as described elsewhere in this disclosure. By way of non-limiting example, a payee user may use element 291 to scan a barcode, which is displayed to the payee user on his computing device. Element 291 may be used to receive the token from the payer user.

It is appreciated that the foregoing user interface description is provided for illustrative purposes, and that such features may be used in combination with other user interface features (e.g., merchant POS, online e-commerce interface, etc.). Moreover, it is appreciated that not all features need be included for any user interface described herein, and that more features than those disclosed herein may further be included to support the entirety of the systems and methods described herein, as would be appreciated by one having skill in the art.

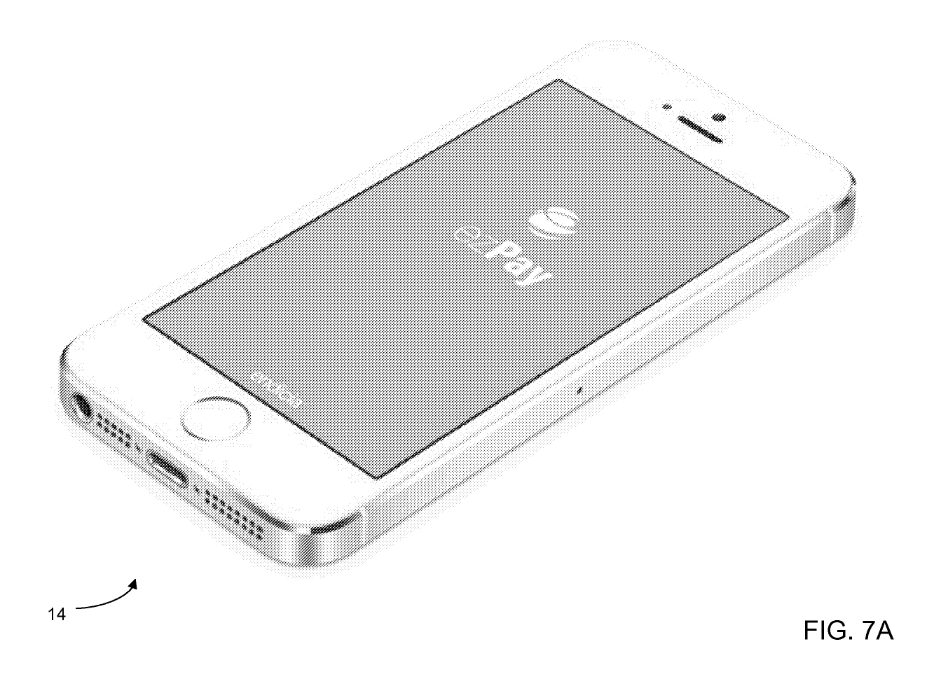

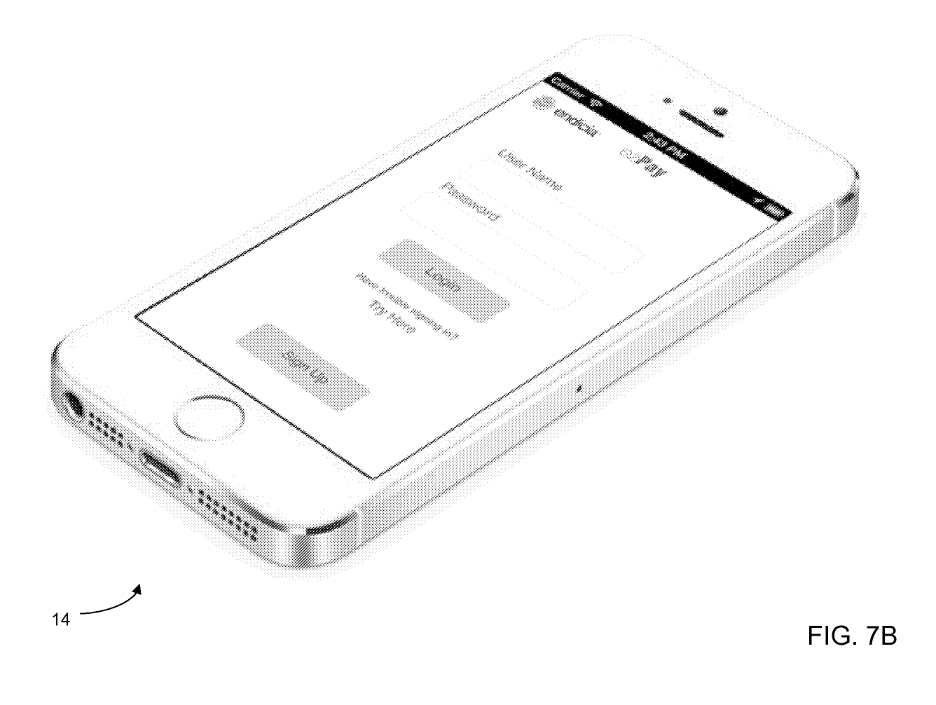

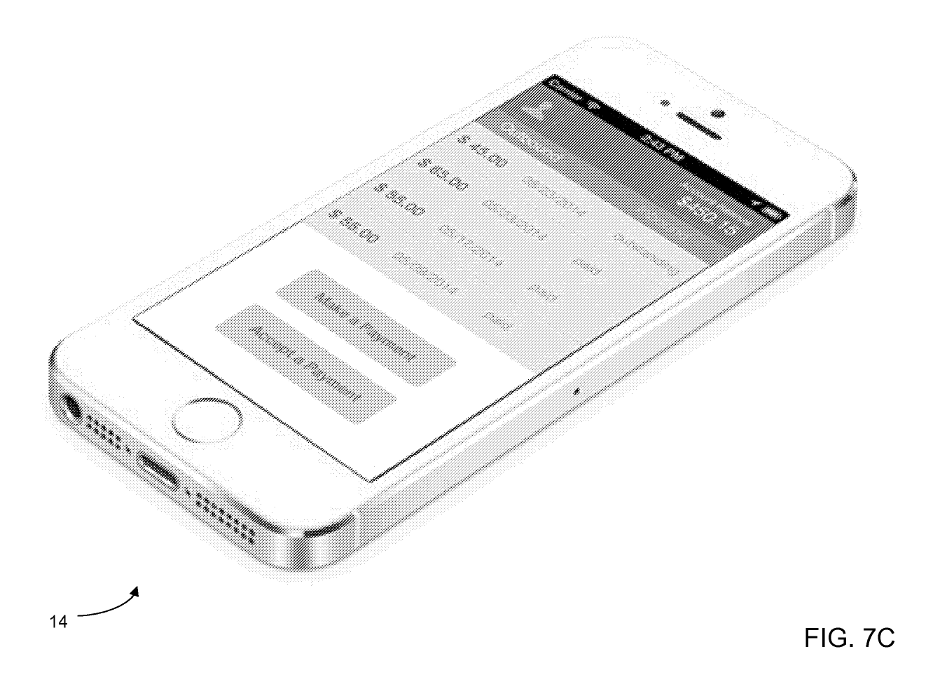

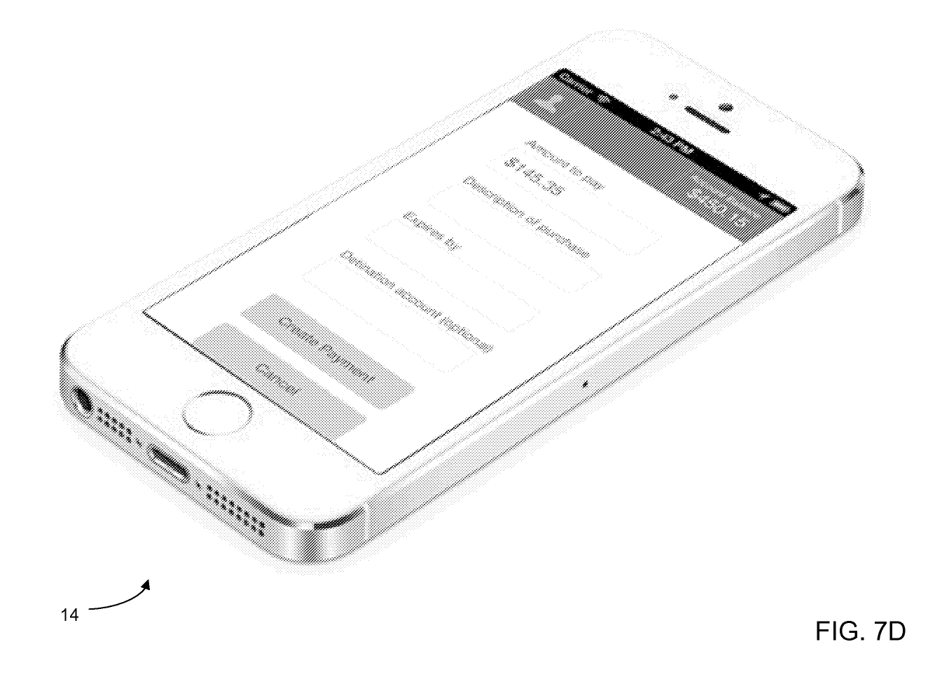

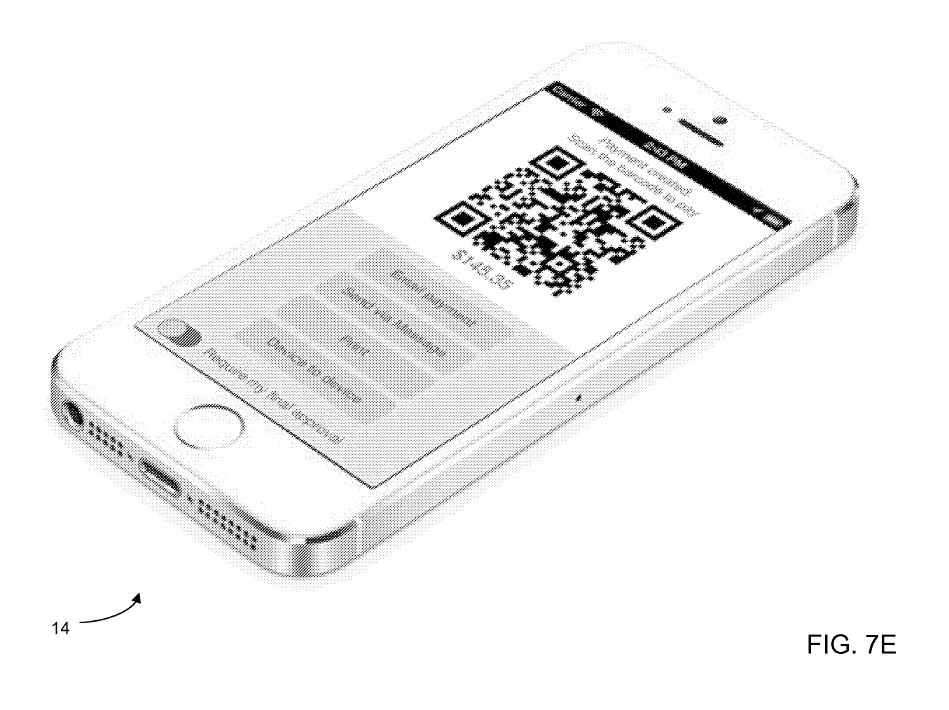

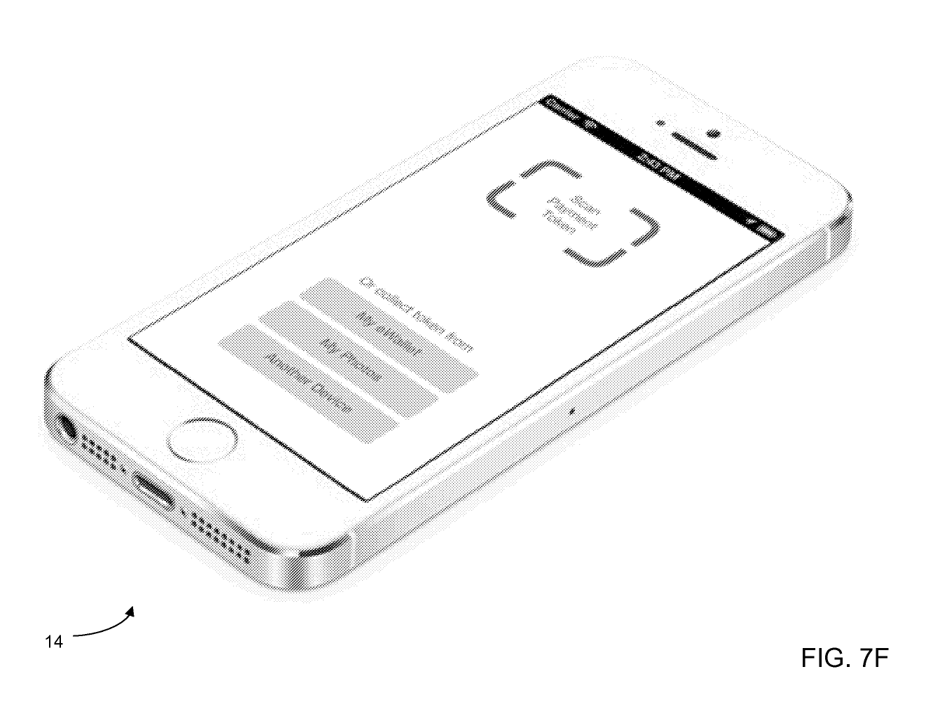

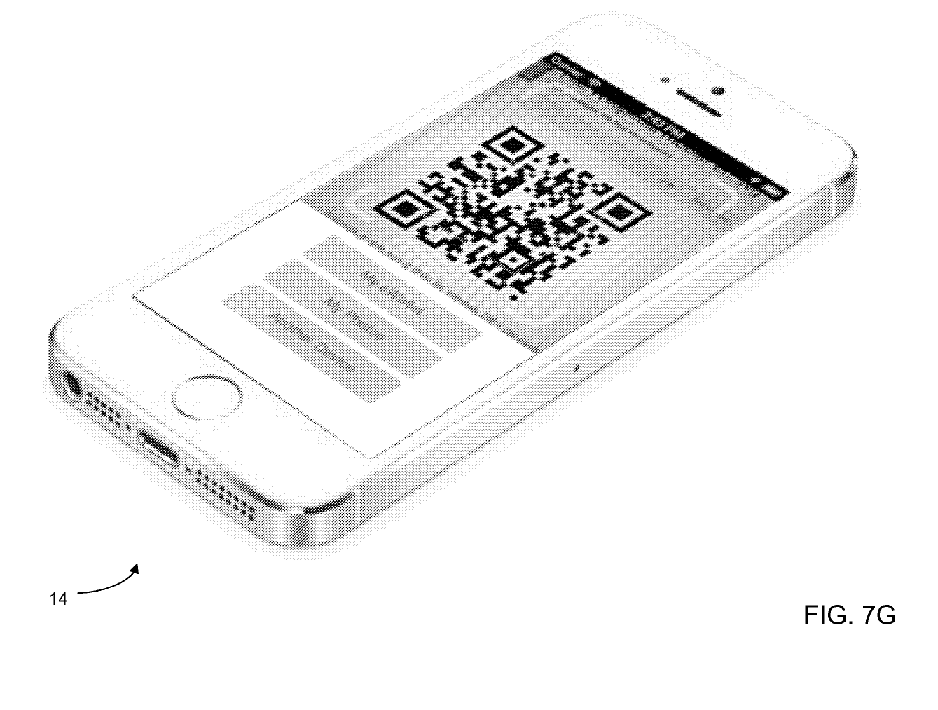

FIG. 7A-7G illustrate exemplary graphical user interfaces for a client computing platform 14 as may be used in a payment system in accordance with one or more implementations. FIGS. 7A and 7B illustrate a user interface as may be used to log in to an account, e.g., a secured transaction account. FIG. 7C illustrates a user interface as may be used for a typical account summary screen and/or account summary interface, including two action choices for make a payment and accepting a payment. FIG. 7D illustrates a user interface as may be used for a typical prompting (e.g., the payer is prompted via this user interface) for the amount of the payment, an optional description, an optional expiration date, and an optional destination account identifier (that identifies a recipient's secured transaction account). FIG. 7E illustrates a user interface as may be displayed and/or presented, to a payer, with a variety of offered transfer mechanisms. Note that the payment token in FIG. 7E is displayed, by way of non-limiting example, as a two-dimensional barcode. FIG. 7F illustrates a user interface as may be used by a client computing platform associated with a recipient, e.g., a point of sale system. The user interface illustrated in FIG. 7F may be used to offer the recipient multiple ways to receive a payment token, including but not limited to scanning an image that includes the payment token. FIG. 7G illustrates a user interface as may be used during image capture of a two-dimensional barcode image of a payment token, e.g., through scanning or by taking a photograph. Upon successful capture of a payment token, the recipient may redeem the payment token as described in this disclosure.

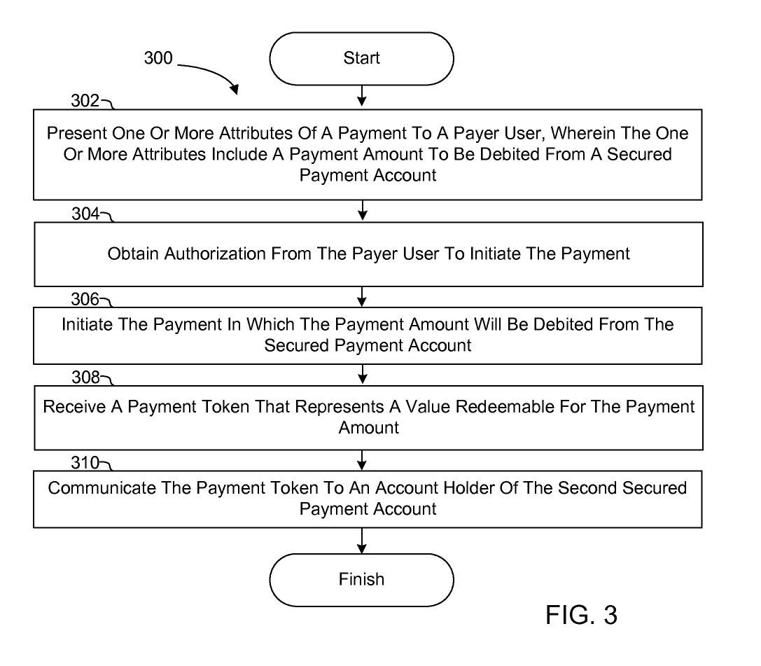

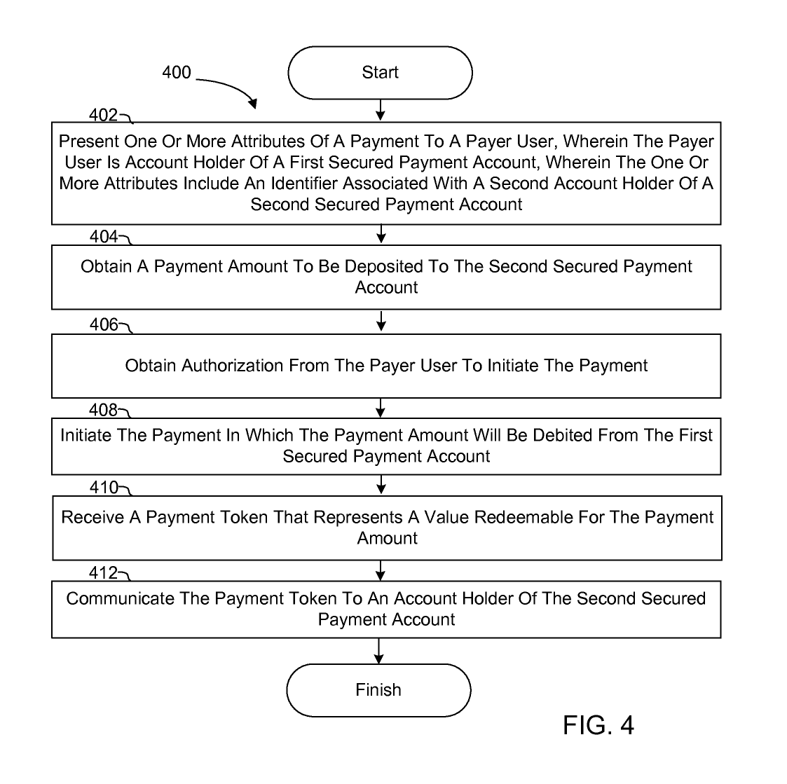

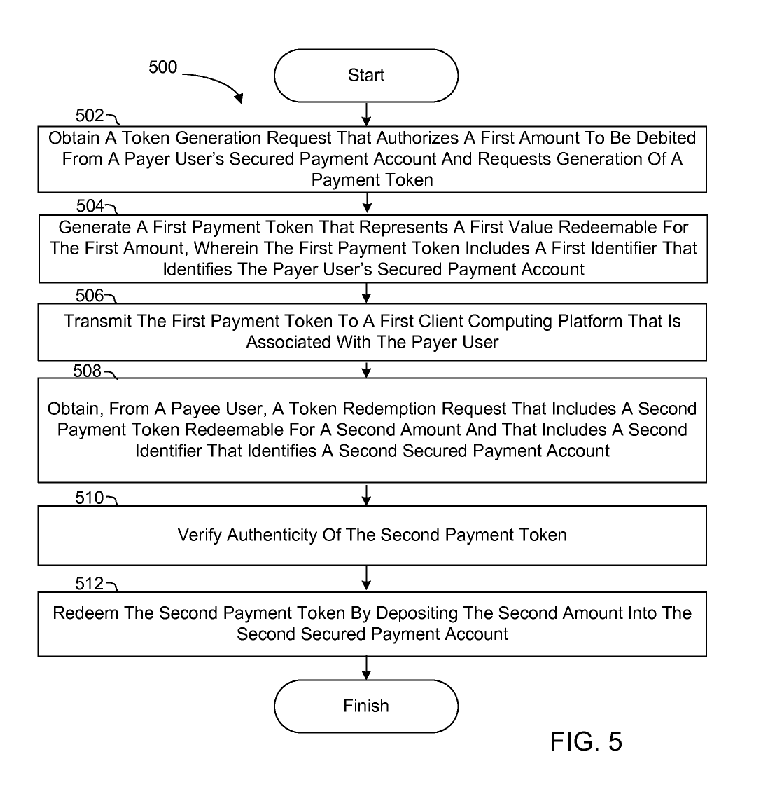

FIGS. 3-4-5 illustrate example methods 300-400-500 for implementing secured payments. The operations of methods 300-400-500 presented herein are intended to be illustrative. In some implementations, methods 300-400-500 may be accomplished with one or more additional operations not described, and/or without one or more of the operations discussed. Additionally, the orders in which the operations of methods 300-400-500 are illustrated in FIG. 3, FIG. 4, and FIG. 5, and described herein, are not intended to be limiting.

Method 300 may be interpreted as an exemplary implementation of a secured payment from the perspective of a payer user, e.g., through a client computing device associated with the payer user. Regarding FIG. 3 and method 300, at an operation 302, one or more attributes of a payment are presented to a payer user (e.g., a payer). The one or more attributes include a payment amount to be debited from a secured payment account. In some implementations, operation 302 is performed by a presentation component the same as or similar to presentation component 22 (shown in FIG. 1 and described herein).

At an operation 304, authorization is obtained from the payer user to initiate the payment. In some implementations, operation 304 is performed by an authorization component the same as or similar to authorization component 23 (shown in FIG. 1 and described herein). From the perspective of a payer user, authorization may be obtained through the user interface of the payer client computing device, e.g. through logging in and tapping the button to request generation of a payment token. The transaction itself, and likely the initiation of the transaction as well, may occur on the server side, outside of the perspective of the payer user. The payer user may merely initiate and/or authorizes that a particular secured payment occurs, e.g. that a payment token is generated.

At an operation 306, the payment in which the first amount will be debited from the secured payment account is initiated. In some implementations, operation 306 is performed by an initiation component the same as or similar to initiation component 24 (shown in FIG. 1 and described herein).

At an operation 308, a payment token is received that represents a value redeemable for the payment amount. In some implementations, operation 308 is performed by a transceiver component the same as or similar to transceiver component 30 (shown in FIG. 1 and described herein).

At an operation 310, the payment token is communicated to an account holder of the second secured payment account. In some implementations, operation 310 is performed by a transceiver component the same as or similar to transceiver component 30 (shown in FIG. 1 and described herein).

Method 400 may be interpreted as an exemplary implementation of a secured payment from the perspective of a payer user, e.g., through a client computing device associated with the payer user. The payer user may be the account holder of a first secured payment account. Regarding FIG. 4 and method 400, at an operation 402, one or more attributes of a payment are presented to a payer user (e.g., a payer). The one or more attributes include an identifier associated with a second account holder of a second secured payment account (e.g., a payee and/or merchant may be the account holder of the second secured payment account). In some implementations, operation 402 is performed by a presentation component the same as or similar to presentation component 22 (shown in FIG. 1 and described herein). For example, to start a payment, the merchant or the POS system may cause the target recipient, e.g. the name of a restaurant, to be presented to the payer user. In this example, the payer user may enter the dollar amount to be transferred/paid. For example, the payer user may decide to add a tip to the amount due.

At an operation 404, a payment amount to be deposited to the second secured payment account is obtained. In some implementations, operation 404 is performed by an interface component the same as or similar to interface component 42 (shown in FIG. 1 and described herein).

At an operation 406, authorization is obtained from the payer user to initiate the payment. The authorization pertains to the first secured payment account. In some implementations, operation 406 is performed by an authorization component the same as or similar to authorization component 23 (shown in FIG. 1 and described herein). In some implementations, authorization may be obtained at the payer user's device.

At an operation 408, the payment in which the first amount will be debited from the first secured payment account is initiated. In some implementations, operation 408 is performed by an initiation component the same as or similar to initiation component 24 (shown in FIG. 1 and described herein).

At an operation 410, a payment token is received that represents a value redeemable for the payment amount. In some implementations, operation 410 is performed by a transceiver component the same as or similar to transceiver component 30 (shown in FIG. 1 and described herein).

At an operation 412, the payment token is communicated to an account holder of the second secured payment account. In some implementations, operation 412 is performed by a transceiver component the same as or similar to transceiver component 30 (shown in FIG. 1 and described herein).

Method 500 may be interpreted as an exemplary implementation of a secured payment from the perspective of a centralized payment authority, e.g., through one or more computing devices. Regarding FIG. 5 and method 500, at an operation 502, a token generation request is obtained from a payer user by a centralized payment authority. The token generation request authorizes a first amount to be debited from the payer user's secured payment account and requests generation of a payment token that is redeemable by a payee user for the first amount. In some implementations, operation 502 is performed by a token request component the same as or similar to token request component 28 (shown in FIG. 1 and described herein).

At an operation 504, a first payment token is generated that represents a first value redeemable for the first amount. The first payment token includes a first identifier that identifies the payer user's secured payment account. In some implementations, operation 504 is performed by a token generation component the same as or similar to token generation component 29 (shown in FIG. 1 and described herein).

At an operation 506, the first payment token is transmitted to a first client computing platform that is associated with the payer user. In some implementations, operation 506 is performed by a transceiver component the same as or similar to transceiver component 30 (shown in FIG. 1 and described herein).

At an operation 508, a token redemption request is obtained from the payee user by the centralized payment authority. In one implementation, the act of receiving the token for redemption from the payee user will provide sufficient information to identify the payee user's secured payment account with the centralized authority (e.g., by sending via its account on its merchant application, etc.). However, in some implementations, the payment token may optionally include an identifier that identifies the payee user's secured payment account with the centralized payment authority, which may serve to further identify into which account the secured payment is to be credited. In some implementations, operation 508 is performed by a token redemption component the same as or similar to token redemption component 31 (shown in FIG. 1 and described herein).

At an operation 510, authenticity of the payment token is verified, for example by the centralized payment authority. In some implementations, operation 510 may also be performed by a payee user's computer (e.g., a client computing device associated with the payee user) to provide an additional optional authentication step using the public key(s) distributed by the centralized payment authority, such as by a user security component the same as or similar to user security component 27 (shown in FIG. 1 and described herein).

At an operation 512, responsive to verification of authenticity, the payment token is redeemed by depositing the second amount into the payee user's secured payment account. In some implementations, operation 512 is performed by a token redemption component the same as or similar to token redemption component 31 (shown in FIG. 1 and described herein).

In some implementations, methods 300-400-500 may be implemented in one or more processing devices (e.g., a computing device, a server, a digital processor, an analog processor, a digital circuit designed to process information, an analog circuit designed to process information, and/or other mechanisms for electronically processing information), such as one or more described in more detail with reference to FIG. 1. The one or more processing devices may include one or more devices executing some or all of the operations of methods 300-400-500 in response to instructions stored electronically on an electronic and/or physical storage medium. The one or more processing devices may include one or more devices configured through hardware, firmware, and/or software to be specifically designed for execution of one or more of the operations of methods 300-400-500.

Referring back to FIG. 1, one or more processors 20 may be configured to provide information processing capabilities in system 10 and/or computing device 11. As such, processor 20 may include one or more of a digital processor, an analog processor, a digital circuit designed to process information, an analog circuit designed to process information, a state machine, and/or other mechanisms for electronically processing information. Although processor 20 may be shown in FIG. 1 as a single entity, this is for illustrative purposes only. In some implementations, processor 20 may include a plurality of processing units. These processing units may be physically located within the same device, or processor 20 may represent processing functionality of a plurality of devices operating in coordination (e.g., “in the cloud”, and/or other virtualized processing solutions).

It should be appreciated that although components 22-33, are illustrated in FIG. 1 as being co-located within a single processing unit, in implementations in which processor 20 includes multiple processing units, one or more of components 22-33 may be located remotely from the other components. For example, one or more of components 22-33 may be located in one or more client computing platforms, a point-of-sale system, one or more computing devices, and/or any combination thereof. The description of the functionality provided by the different components 22-33 described herein is for illustrative purposes, and is not intended to be limiting, as any of components 22-33 may provide more or less functionality than is described. For example, one or more of components 22-33 may be eliminated, and some or all of its functionality may be provided by other ones of components 22-33. As another example, processor 20 may be configured to execute one or more additional components that may perform some or all of the functionality attributed herein to one of components 22-33.

Physical storage 60 of system 10 in FIG. 1 may comprise electronic storage media that stores information. In some implementations, physical storage 60 may store representations of computer program components, including instructions that implement the computer program components. The electronic storage media of physical storage 60 may include one or both of system storage that is provided integrally (i.e., substantially non-removable) with computing device 11 and/or removable storage that is removably connectable to computing device 11 via, for example, a port (e.g., a USB port, a FireWire™ port, etc.) or a drive (e.g., a disk drive, etc.). Physical storage 60 may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), network-attached storage (NAS), and/or other electronically readable storage media. Physical storage 60 may include virtual storage resources, such as storage resources provided via a cloud and/or a virtual private network. Physical storage 60 may store software algorithms, information determined by processor 20, information received via client computing platforms 14, and/or other information that enable computing device 11 and system 10 to function properly. Physical storage 60 may be separate components within system 10, or physical storage 60 may be provided integrally with one or more other components of system 10 (e.g., processor 20).

In view of the foregoing disclosure, it should be readily appreciated that the systems and methods described herein provide secured payment features that may be unavailable through other platforms for secured payment transactions, including but not limited to credit cards, ACH transfers, conventional checks, digital currencies, electronic payment protocols, and/or other platforms for secured payment transactions. Such distinctions are highlighted as an example below.

Comparison with Credit Cards: When a credit card is physically handed to a waiter, a retail clerk, or submitted to an e-commerce site, the card holder is essentially giving that party full access to the credit card account. The credit card number, expiration date and CVV2 code can be captured, stored, and/or transferred manually and/or electronically. Subsequently, the card information may be used to make unauthorized purchases. (This may be done by comprising an e-commerce site where credit card information is stored.) Likewise, giving credit card information to any party is essentially handing that party full access to the account.

In contrast, when using the systems and methods described in this disclosure, the secured payment account holder is handing over a specific, digitally-signed representation of a particular dollar value that can be debited from the payer's secured account and deposited to another secured payment account. Because it is digitally signed by the centralized authority, the transaction can't be spoofed. And because the redemption of this transaction locks out any subsequent attempt to redeem, the transaction can only be used once. This is substantially more secure on a transaction by transaction basis.

An additional, optional level of security is provided by notifying the issuer (e.g., payer) of the transaction when a redemption is about to take place and by whom. The issuer can optionally have an opportunity to approve the redemption step via a variety of secure communication protocols, as described herein.

Comparison with ACH Bank Transfers: ACH (Automated Clearing House) is a government run system which allows funds to be transferred from one bank account to another. There are debit and credit permutations of this system. ACH is a relatively low cost transfer system but it is not a real time system. If a transfer request is submitted to the ACH network, it takes about 24 hours to be processed. If there are insufficient funds in the source account or some other problem, it typically takes 2 to 3 days before this information is reported to the party that instituted the transfer. There is no real time verification that the source account has sufficient funds to meet the transfer request. This latency exposes this network to substantial inefficiencies and fraud.

In contrast, the systems and methods described in this disclosure provide that the origin source has sufficient funds for the transaction at the instant the transfer is started. The successful completion of the transfer is monitored using a real-time feedback system.

Comparison with conventional checks: Checks have been susceptible to counterfeiting schemes for decades—both of the check itself, the signature and the bank credentials (account and routing number). There is a surprisingly crude network for real time verification of a check, largely because checks can be issued by any number of banking and financial institutions—all of whom have disparate and unlinked computer systems. The systems and methods described in this disclosure feature a centralized network for secured funds transfer and account verification, and the payment token carries a digital authentication signature which verifies its authenticity and origin.

Comparison with digital currency systems: Digital currency (e.g., Bitcoin) is a currency in of itself. Its value fluctuates substantially based on a myriad of factors. The systems and methods described in this disclosure are based on conventional currencies such as the US Dollar, Euro, Japanese Yen, and/or other conventional currencies. This disclosure is focused on ultra-secure transfer of these funds from one party to another.

Comparison with electronic payment protocols: Electronic payment systems, (e.g., PayPal and similar systems) omit crucial features described in the systems and methods in this disclosure. The systems and methods described in this disclosure provide a wide variety of ways to convey the transaction from one party to another (including but not limited to a binary data stream, 2D barcodes, near field communication, Bluetooth, hard copy, email, Web page). Furthermore, each transaction is digitally signed by the central authority so the authenticity and originator of the transaction can be verified independently in a wide variety of environments using public/private key technology. Thus, the representation of each transaction is more secure and much more easily exchanged between parties. Moreover, in a large number of PayPal (and similar systems) transactions, there still exist accompanying transactions with conventional financial instruments, such as credit card or bank transfers to fund the payments in association with each payment being made.

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation (or claim) can be combined with one or more features of any other implementation (or claim).

What is claimed is:

1. A system configured to implement a payment platform for users using secured payment accounts, wherein the users are account holders of the secured payment accounts, wherein the users include a first user and a second user, wherein the first user is account holder of a first secured payment account, wherein the second user is account holder of a second secured payment account, the system comprising:
one or more physical processors configured by machine-readable instructions to:
obtain, from the first user, a token generation request, wherein the token generation request authorizes a first amount to be debited from the first secured payment account and requests generation of a payment token that is redeemable for the first amount;
generate a first payment token that represents a first value redeemable for the first amount;
transmit the first payment token to a first client computing platform that is associated with the first user;
obtain, from the second user, a token redemption request that includes a second payment token that represents a second value redeemable for a second amount;
verify authenticity of the second token;
responsive to verification of authenticity, redeem the second payment token by depositing the second amount into the second secured payment account.

2. The system of claim 1, wherein the first payment token includes a first identifier that identifies the first secured payment account.

3. The system of claim 1, wherein the one or more physical processors are further configured to receive, on behalf of the first user, account authentication that authenticates access to the first secured payment account.

4. The system of claim 1, wherein the one or more physical processors are further configured to verify whether a balance of the first secured payment account is sufficient to debit the first amount.

5. The system of claim 1, wherein the first payment token is digitally signed.

6. The system of claim 1, wherein the first payment token includes a digital signature that is verifiable through a public encryption key.

7. The system of claim 1, wherein the first payment token is configured for one-time use.

8. The system of claim 1, wherein the first payment token includes a token count that is associated with the first secured payment account.

9. The system of claim 1, wherein the one or more physical processors are further configured to, responsive to receipt of the token generation request, debit the first amount from the first secured payment account.

10. The system of claim 1, wherein the first payment token includes binary data formatted as at least one of an American Standard Code for Information Interchange (ASCII) string and a two-dimensional barcode.

11. The system of claim 1, wherein the token redemption request includes an identifier that identifies the second secured payment account.

12. The system of claim 1, wherein the token redemption request is obtained from a second client computing device that is associated with the second user.

13. The system of claim 1, wherein the second payment token is based on the first payment token.

14. The system of claim 1, wherein the second payment token includes a digital signature that is verifiable through a public encryption key.

15. The system of claim 1, wherein the one or more physical processors are configured to verify authenticity of the second payment token by checking a digital signature in the second payment token with an associated public encryption key.

16. The system of claim 1, wherein the one or more physical processors are configured to verify authenticity of the second payment token by determining whether the second amount matches the first amount.

17. The system of claim 1, wherein the one or more physical processors are configured to verify authenticity of the second payment token by determining whether the secured payment account identified by the second identifier matches the first secured payment account.

18. The system of claim 1, wherein the one or more physical processors are configured to verify authenticity of the second payment token by determining whether the second payment token has been redeemed.

19. The system of claim 1, wherein the one or more physical processors are further configured to determine whether the second payment token has been redeemed by inspecting a transaction history of the first secured payment account.

20. The system of claim 1, wherein the one or more physical processors are further configured to determine an association between the second payment token and the first payment token.

21. The system of claim 1, wherein the one or more physical processors are further configured to mark the second payment token as redeemed.

22. The system of claim 1, wherein the one or more physical processors are configured to redeem the second payment token through a centralized payment authority.

23. The system of claim 1, wherein the one or more physical processors are further configured to charge the second user a transaction fee upon redemption of the second payment token.

24. The system of claim 1, wherein the one or more physical processors are further configured to receive, on behalf of the second user, account authentication that authenticates access to the second secured payment account.

25. The system of claim 1, wherein the first payment token includes a second identifier that identifies the second secured payment account.

26. The system of claim 1, wherein the first payment token is configured to expire after a predetermined duration, and wherein redemption of the second payment token is conditional on the first payment token not having expired.

27. The system of claim 1, wherein the one or more physical processors are further configured to:
transmit, to the first client computing platform, an indicator that indicates a request for confirmation of redemption of the second payment token; and
obtain the confirmation,
wherein redemption of the second payment token is conditional on obtainment of the confirmation.

28. A computer-implemented method to effectuate performance of secured payment transactions involving secured payment accounts, wherein the secured payment accounts include a first secured payment account and a second secured payment account, wherein a first user is account holder of the first secured payment account and the second user is account holder of the second secured payment account, the method being implemented in a computer system that includes one or more physical processors, the method comprising:
obtaining, from the first user, a token generation request, wherein the token generation request authorizes a first amount to be debited from the first secured payment account and requests generation of a payment token that is redeemable for the first amount;
generating a first payment token that represents a first value redeemable for the first amount, wherein the first payment token includes a first identifier that identifies the first secured payment account;
transmitting the first payment token to a first client computing platform that is associated with the first user;
obtaining, from the second user, a token redemption request that includes a second payment token that represents a second value redeemable for a second amount, wherein the token redemption request includes a second identifier that identifies the second secured payment account;
verifying authenticity of the second payment token;
responsive to verification of authenticity, redeeming the second payment token by depositing the second amount into the secured payment financial account.
Additional claims:
A system configured to implement a payment platform for users using secured payment accounts, wherein the users are account holders of the secured payment accounts, wherein the users include a first user and a second user, wherein the first user is account holder of a first secured payment account, wherein the second user is account holder of a second secured payment account, the system comprising:
one or more physical processors configured by machine-readable instructions to:
receive, on behalf of the first user, account authentication that authenticates access to the first secured payment account;
obtain, from the first user, a token generation request, wherein the token generation request (a) authorizes a first amount to be debited from the first secured payment account and (b) requests generation of a payment token that is redeemable for the first amount;
responsive to receipt of the token generation request, generate a first token, wherein the first token includes:
(a) a digitally-signed payment token representing a first value redeemable for the first amount, and
(b) a first identifier that identifies the first secured payment account,
responsive to receipt of the token generation request, debit the first amount from the first secured payment account;
transmit the first token to a first client computing platform that is associated with the first user;
obtain, from the second user, a token redemption request, wherein the token redemption request includes an identifier that identifies the second secured payment account, wherein the token verification request further includes a second token, and wherein the second token is based on the first token, wherein the second token includes:
(a) a second digitally-signed payment token representing a second value redeemable for a second amount,
(b) a second identifier that identifies a secured payment account;
verify authenticity of the second token by checking a digital signature in the second token with an associated public encryption key determine an association between the second token and the first token;
verify whether the second amount matches the first amount;
verify whether the secured payment account identified by the second identifier matches the first secured payment account;
verify whether the second token has been redeemed; and
redeem the second token by depositing the second amount into the second secured payment account.
